(19) United States
(12) Patent Application Publication
(10) Pub. No.: US 2022/0322272 A1
(43) Pub. Date: Oct. 6, 2022

(54) NO-DELAY SCHEDULED LOCATION REQUEST

(71) Applicant: QUALCOMM Incorporated, San Diego, CA (US)

(72) Inventors: Sony Akkarakaran, Poway, CA (US); Stephen William Edge, Escondido, CA (US); Jingchao Bao, San Diego, CA (US)

(21) Appl. No.: 17/219,451

(22) Filed: Mar. 31, 2021

(51) Int. Cl. H04W 64/00; H04W 28/02

(52) U.S. Cl. CPC H04W 64/00; H04W 28/0268

(57) ABSTRACT

Disclosed are techniques for no-delay scheduled location requests. In an aspect, a user equipment (UE) receives, from a network node, a no-delay scheduled location request that identifies a future time T1 for reporting a location of the UE, e.g., a scheduled location request having a response quality of service (QoS) attribute indicating no delay. In some aspects, the UE determines, at time T2<T1, an actual or predicted location for the UE at time T1. The UE reports, to the network node, the location for the UE at time T1 as determined at time T2. In some aspects, the UE determines, at time T1, that its location is still unknown, and either reports an error with zero delay or performs a location determination and reports its location with non-zero delay.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a user equipment (UE) includes receiving, from a network node, a no-delay scheduled location request that identifies a future time T1 for reporting a location of the UE; and determining, at a time T2 that occurs before time T1, location information for the expected location of the UE at time T1, the location information comprising a location measurement, a determined location that is determined based on a location measurement, or combinations thereof.

In an aspect, a method of wireless communication performed by a UE includes receiving, from a network node, a no-delay scheduled location request that identifies a future time T1 for reporting a location of the UE; determining, at time T1, that a location of the UE is not yet known; and either: determining location information for the UE, the location information comprising a location measurement, a determined location that is determined based on a location measurement, or combinations thereof, and reporting the location information for the UE to the network node with non-zero delay; or reporting an error to the network node with zero delay.

In an aspect, a method of wireless communication performed by a network node includes determining that a location of a UE at a future time T1 is desired; and sending, to the UE, a no-delay scheduled location request that identifies a future time T1 for reporting a location of the UE.

In an aspect, a method of wireless communication performed by a network node includes determining that a location of a UE at a future time T1 is desired; determining that a no-delay scheduled location request that identifies the future time T1 for reporting a location of the UE may not complete before time T1; and performing one of: sending, to the UE, a with-delay scheduled location request for time T1; sending, to the UE, a with-delay non-scheduled location request for time T1; sending to the UE, a no-delay non-scheduled location request for time T1; sending, to the UE, a no-delay scheduled location request for a time T3 that occurs after time T1; or waiting until time T1, and then sending, to the UE, a with-delay non-scheduled location request.

In an aspect, a UE includes a memory; a communication interface; and at least one processor communicatively coupled to the memory and the communication interface, the at least one processor configured to: receive, via the communication interface, from a network node, a no-delay scheduled location request that identifies a future time T1 for reporting a location of the UE; and determine, at time T2 that occurs before time T1, location information for the expected location of the UE at time T1, the location information comprising a location measurement, a determined location that is determined based on a location measurement, or combinations thereof.

In an aspect, a UE includes a memory; a communication interface; and at least one processor communicatively coupled to the memory and the communication interface, the at least one processor configured to: receive, via the communication interface, from a network node, a no-delay scheduled location request that identifies a future time T1 for reporting a location of the UE; determine, at time T1, that a location of the UE is not yet known; and either: determine the location information for the UE, the location information comprising a location measurement, a determined location that is determined based on a location measurement, or combinations thereof, and report the location information for the UE to the network node with non-zero delay; or report an error to the network node with zero delay.

In an aspect, a network node includes a memory; a communication interface; and at least one processor communicatively coupled to the memory and the communication interface, the at least one processor configured to: determine that a location of a UE at a future time T1 is desired; and cause the communication interface to send, to the UE, a no-delay scheduled location request that identifies the future time T1 for reporting a location of the UE.

In an aspect, a network node includes a memory; a communication interface; and at least one processor communicatively coupled to the memory and the communication interface, the at least one processor configured to: determine that a location of a UE at a future time T1 is desired; determine that a no-delay scheduled location request that identifies the future time T1 for reporting a location of the UE may not complete before time T1; and perform one of: send, to the UE, a with-delay scheduled location request; send, to the UE, a with-delay non-scheduled location request; send to the UE, a no-delay non-scheduled location request; or wait until time T1, and then send, to the UE, a with-delay non-scheduled location request.

In an aspect, a UE includes means for receiving, from a network node, a no-delay scheduled location request that identifies a future time T1 for reporting a location of the UE; and means for determining, at a time T2 that occurs before time T1, location information for the expected location of the UE at time T1, the location information comprising a location measurement, a determined location that is determined based on a location measurement, or combinations thereof.

In an aspect, a UE includes means for receiving, from a network node, a no-delay scheduled location request that identifies a future time T1 for reporting a location of the UE; means for determining, at time T1, that a location of the UE is not yet known; and means for either: determining location information for the UE, the location information comprising a location measurement, a determined location that is determined based on a location measurement, or combinations thereof, and reporting the location information for the UE to the network node with non-zero delay; or reporting an error to the network node with zero delay.

In an aspect, a network node includes means for determining that a location of a UE at a future time T1 is desired; and means for sending, to the UE, a no-delay scheduled location request that identifies the future time T1 for reporting a location of the UE.

In an aspect, a network node includes means for determining that a location of a UE at a future time T1 is desired; means for determining that a no-delay scheduled location request that identifies future time T1 for reporting a location of the UE may not complete before time T1; and means for performing one of: sending, to the UE, a with-delay scheduled location request for time T1; sending, to the UE, a with-delay non-scheduled location request for time T1; sending to the UE, a no-delay non-scheduled location request for time T1; sending, to the UE, a no-delay scheduled location request for a time T3 that occurs after time T1; or waiting until time T1, and then sending, to the UE, a with-delay non-scheduled location request.

In an aspect, a non-transitory computer-readable medium storing computer-executable instructions that, when executed by a UE, cause the UE to: receive, from a network node, a no-delay scheduled location request that identifies a future time T1 for reporting a location of the UE; and determine, at a time T2 that occurs before time T1, location information for the expected location of the UE at time T1, the location information comprising a location measurement, a determined location that is determined based on a location measurement, or combinations thereof.

In an aspect, a non-transitory computer-readable medium storing computer-executable instructions that, when executed by a UE, cause the UE to: receive, from a network node, a no-delay scheduled location request that identifies a future time T1 for reporting a location of the UE; determine, at time T1, that a location of the UE is not yet known; and either: determine the location information for the UE and report the location information for the UE to the network node with non-zero delay; or report an error to the network node with zero delay.

In an aspect, a non-transitory computer-readable medium storing computer-executable instructions that, when executed by a network node, cause the network node to: determine that a location of a UE at a future time T1 is desired; and send, to the UE, a no-delay scheduled location request that identifies the future time T1 for reporting a location of the UE.

In an aspect, a non-transitory computer-readable medium storing computer-executable instructions that, when executed by a network node, cause the network node to: determine that a location of a UE at a future time T1 is desired; determine that a no-delay scheduled location request that identifies future time T1 for reporting a location of the UE may not complete before time T1; and perform one of: send, to the UE, a with-delay scheduled location request for time T1; send, to the UE, a with-delay non-scheduled location request for time T1; send to the UE, a no-delay non-scheduled location request for time T1; send, to the UE, a no-delay scheduled location request for a time T3 that occurs after time T1; or wait until time T1, and then send, to the UE, a with-delay non-scheduled location request.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A and 2B illustrate example wireless network structures, according to aspects of the disclosure.

FIGS. 3A to 3C are simplified block diagrams of several sample aspects of components that may be employed in a user equipment (UE), a base station, and a network entity, respectively, and configured to support communications as taught herein.

FIGS. 4A to 4D are diagrams illustrating example frame structures and channels within the frame structures, according to aspects of the disclosure.

FIG. 5 is a diagram of an example positioning reference signal (PRS) configuration for the PRS transmissions of a given base station, according to aspects of the disclosure.

FIG. 6 is a diagram showing an architecture reference model 600 for location services.

FIGS. 7-10 are flowcharts of example processes associated with a no-delay scheduled location request according to some aspects.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal.

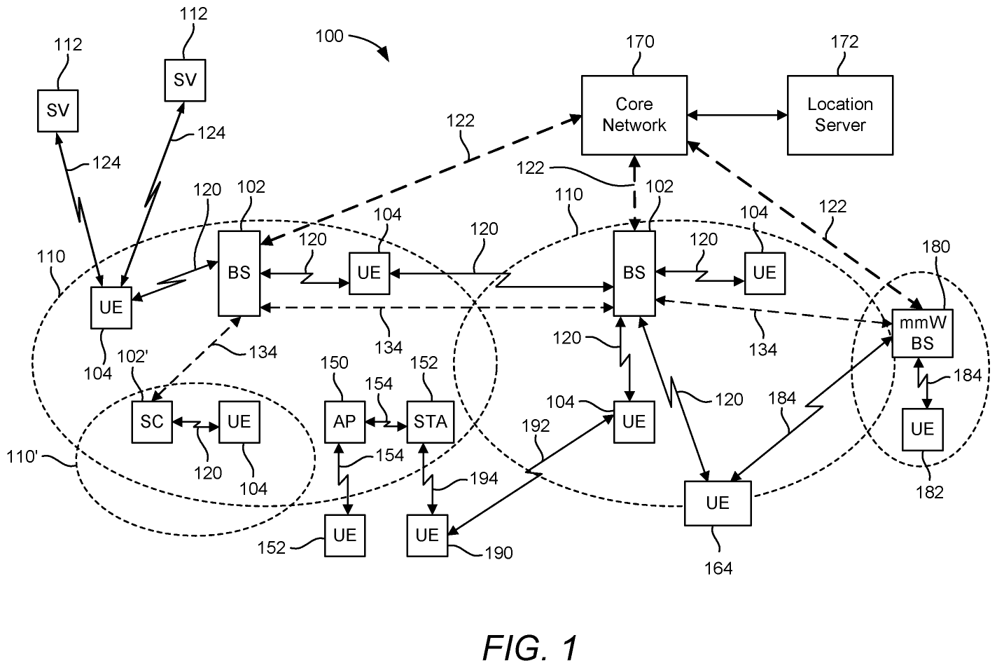

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base station may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell (SC) base station 102′ may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed sub scriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a target reference RF signal on a target beam can be derived from information about a source reference RF signal on a source beam. If the source reference RF signal is QCL Type A, the receiver can use the source reference RF signal to estimate the Doppler shift, Doppler spread, average delay, and delay spread of a target reference RF signal transmitted on the same channel. If the source reference RF signal is QCL Type B, the receiver can use the source reference RF signal to estimate the Doppler shift and Doppler spread of a target reference RF signal transmitted on the same channel. If the source reference RF signal is QCL Type C, the receiver can use the source reference RF signal to estimate the Doppler shift and average delay of a target reference RF signal transmitted on the same channel. If the source reference RF signal is QCL Type D, the receiver can use the source reference RF signal to estimate the spatial receive parameter of a target reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Receive beams may be spatially related. A spatial relation means that parameters for a transmit beam for a second reference signal can be derived from information about a receive beam for a first reference signal. For example, a UE may use a particular receive beam to receive one or more reference downlink reference signals (e.g., positioning reference signals (PRS), tracking reference signals (TRS), phase tracking reference signal (PTRS), cell-specific reference signals (CRS), channel state information reference signals (CSI-RS), primary synchronization signals (PSS), secondary synchronization signals (SSS), synchronization signal blocks (SSBs), etc.) from a base station. The UE can then form a transmit beam for sending one or more uplink reference signals (e.g., uplink positioning reference signals (UL-PRS), sounding reference signal (SRS), demodulation reference signals (DMRS), PTRS, etc.) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

In 5G, the frequency spectrum in which wireless nodes (e.g., base stations 102/180, UEs 104/182) operate is divided into multiple frequency ranges, FR1 (from 450 to 6000 MHz), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In the example of FIG. 1, one or more Earth orbiting satellite positioning system (SPS) space vehicles (SVs) 112 (e.g., satellites) may be used as an independent source of location information for any of the illustrated UEs (shown in FIG. 1 as a single UE 104 for simplicity). A UE 104 may include one or more dedicated SPS receivers specifically designed to receive SPS signals 124 for deriving geo location information from the SVs 112. An SPS typically includes a system of transmitters (e.g., SVs 112) positioned to enable receivers (e.g., UEs 104) to determine their location on or above the Earth based, at least in part, on signals (e.g., SPS signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104.

The use of SPS signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, an SPS may include any combination of one or more global and/or regional navigation satellite systems and/or augmentation systems, and SPS signals 124 may include SPS, SPS-like, and/or other signals associated with such one or more SPS.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on.

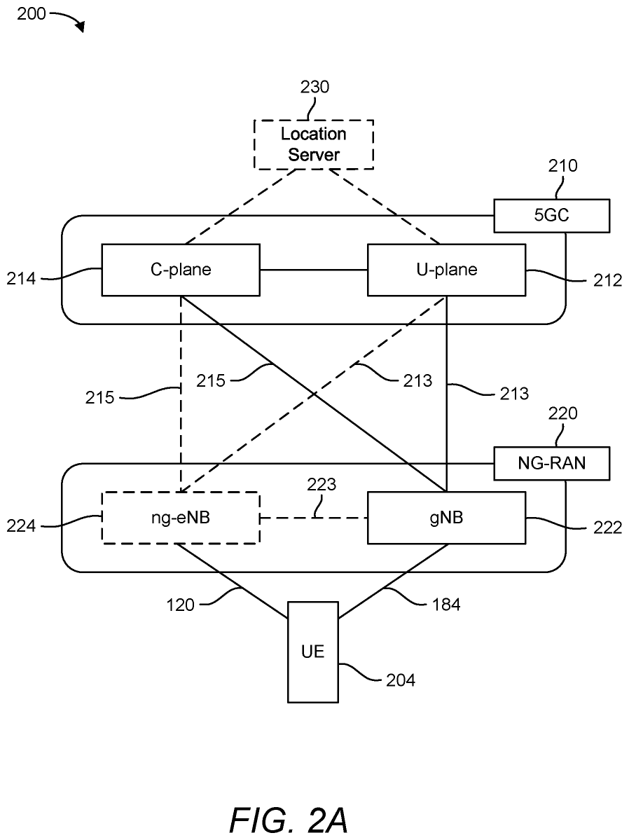

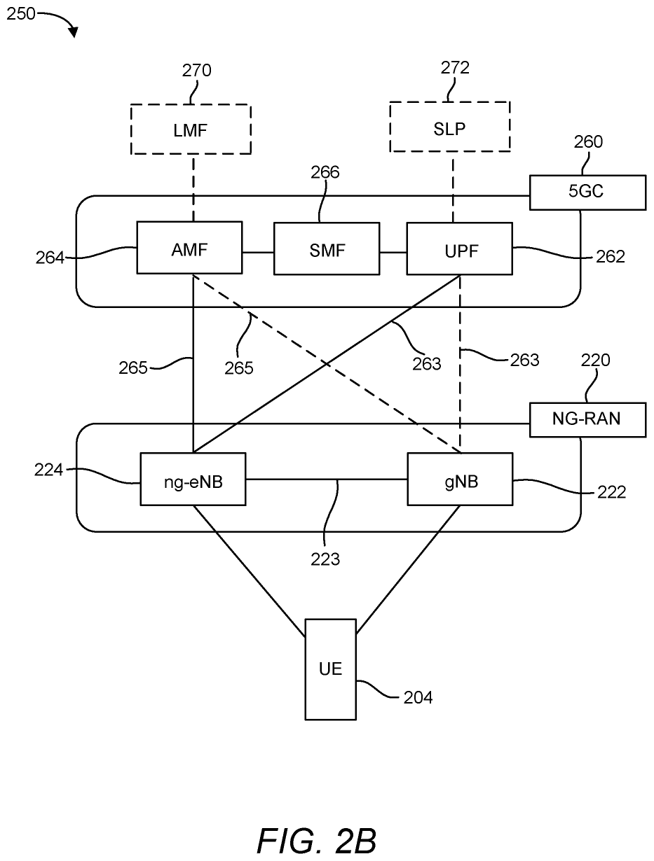

FIG. 2A illustrates an example wireless network structure 200. For example, a 5GC 210 (also referred to as a Next Generation Core (NGC)) can be viewed functionally as control plane functions 214 (e.g., UE registration, authentication, network access, gateway selection, etc.) and user plane functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the control plane functions 214 and user plane functions 212. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may only have one or more gNBs 222, while other configurations include one or more of both ng-eNBs 224 and gNBs 222. Either gNB 222 or ng-eNB 224 may communicate with UEs 204 (e.g., any of the UEs depicted in FIG. 1). Another optional aspect may include location server 230, which may be in communication with the 5GC 210 to provide location assistance for UEs 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network.

FIG. 2B illustrates another example wireless network structure 250. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). User plane interface 263 and control plane interface 265 connect the ng-eNB 224 to the 5GC 260 and specifically to UPF 262 and AMF 264, respectively. In an additional configuration, a gNB 222 may also be connected to the 5GC 260 via control plane interface 265 to AMF 264 and user plane interface 263 to UPF 262. Further, ng-eNB 224 may directly communicate with gNB 222 via the backhaul connection 223, with or without gNB direct connectivity to the 5GC 260. In some configurations, the NG-RAN 220 may only have one or more gNBs 222, while other configurations include one or more of both ng-eNBs 224 and gNBs 222. Either gNB 222 or ng-eNB 224 may communicate with UEs 204 (e.g., any of the UEs depicted in FIG. 1). The base stations of the NG-RAN 220 communicate with the AMF 264 over the N2 interface and with the UPF 262 over the N3 interface.

The functions of the AMF 264 include registration management, connection management, reachability management, mobility management, lawful interception, transport for session management (SM) messages between the UE 204 and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and an LMF 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (not shown in FIG. 2B) over a user plane (e.g., using protocols intended to carry voice and/or data like the transmission control protocol (TCP) and/or IP).

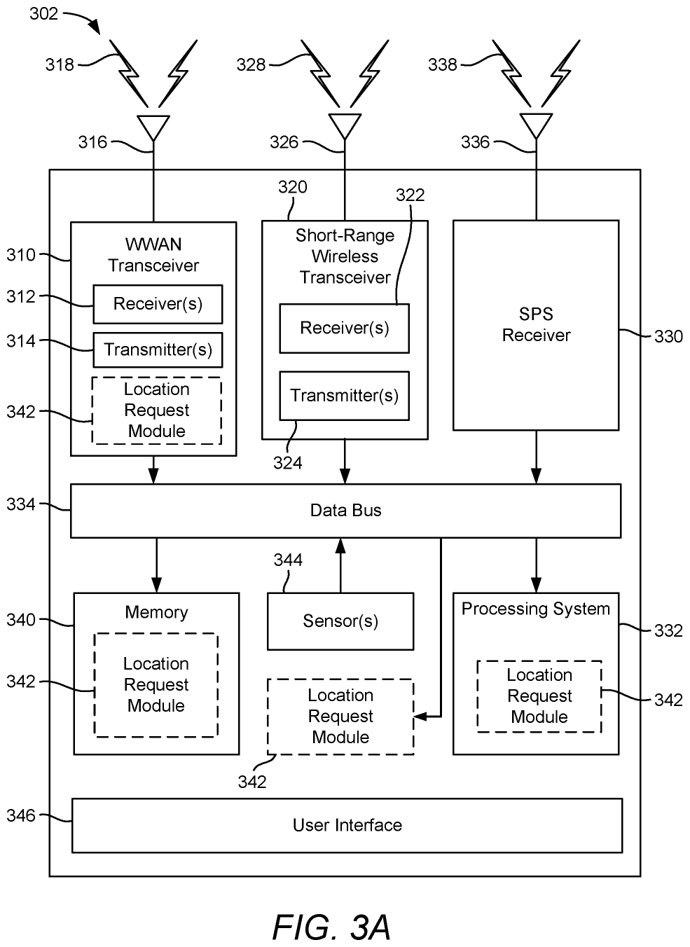

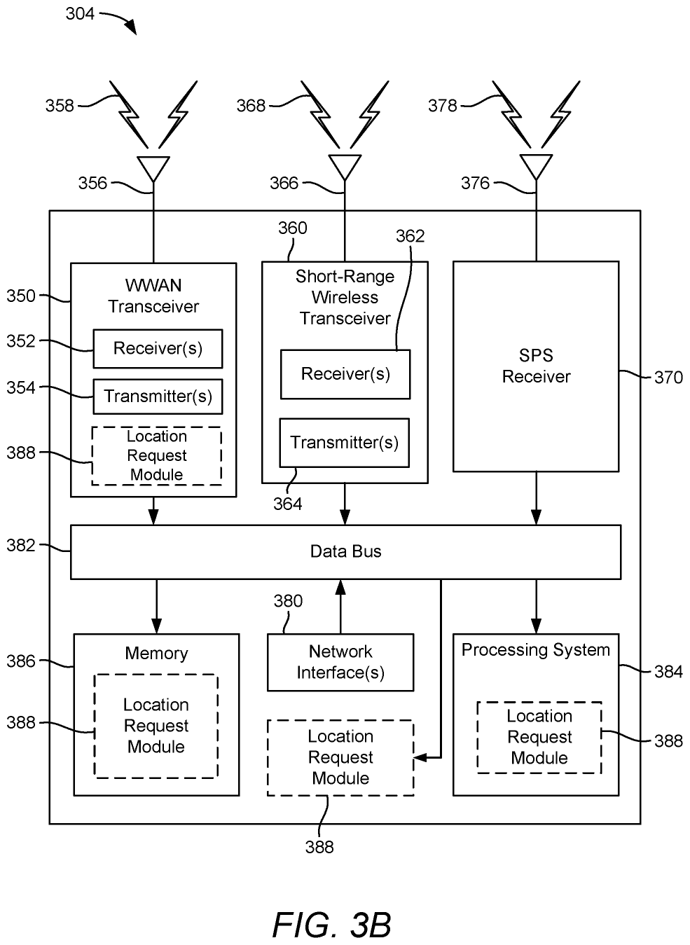

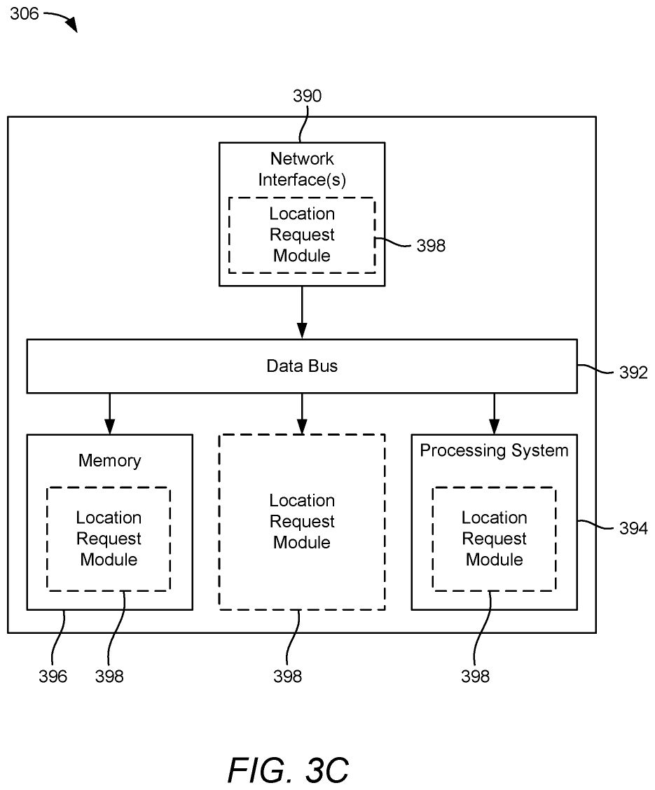

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270) to support the file transmission operations as taught herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include wireless wide area network (WWAN) transceiver 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth®, Zigbee®, Z-Wave®, PC5, dedicated short-range communications (DSRC), wireless access for vehicular environments (WAVE), near-field communication (NFC), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be WiFi transceivers, Bluetooth® transceivers, Zigbee® and/or Z-Wave® transceivers, NFC transceivers, or vehicle-to-vehicle (V2V) and/or vehicle-to-everything (V2X) transceivers.

Transceiver circuitry including at least one transmitter and at least one receiver may comprise an integrated device (e.g., embodied as a transmitter circuit and a receiver circuit of a single communication device) in some implementations, may comprise a separate transmitter device and a separate receiver device in some implementations, or may be embodied in other ways in other implementations. In an aspect, a transmitter may include or be coupled to a plurality of antennas (e.g., antennas 316, 326, 356, 366), such as an antenna array, that permits the respective apparatus to perform transmit “beamforming,” as described herein. Similarly, a receiver may include or be coupled to a plurality of antennas (e.g., antennas 316, 326, 356, 366), such as an antenna array, that permits the respective apparatus to perform receive beamforming, as described herein. In an aspect, the transmitter and receiver may share the same plurality of antennas (e.g., antennas 316, 326, 356, 366), such that the respective apparatus can only receive or transmit at a given time, not both at the same time. A wireless communication device (e.g., one or both of the transceivers 310 and 320 and/or 350 and 360) of the UE 302 and/or the base station 304 may also comprise a network listen module (NLM) or the like for performing various measurements.

The UE 302 and the base station 304 also include, at least in some cases, satellite positioning systems (SPS) receivers 330 and 370. The SPS receivers 330 and 370 may be connected to one or more antennas 336 and 376, respectively, and may provide means for receiving and/or measuring SPS signals 338 and 378, respectively, such as global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. The SPS receivers 330 and 370 may comprise any suitable hardware and/or software for receiving and processing SPS signals 338 and 378, respectively. The SPS receivers 330 and 370 request information and operations as appropriate from the other systems, and perform calculations necessary to determine positions of the UE 302 and the base station 304 using measurements obtained by any suitable SPS algorithm.

The base station 304 and the network entity 306 each include at least one network interfaces 380 and 390, respectively, providing means for communicating (e.g., means for transmitting, means for receiving, etc.) with other network entities. For example, the network interfaces 380 and 390 (e.g., one or more network access ports) may be configured to communicate with one or more network entities via a wire-based or wireless backhaul connection. In some aspects, the network interfaces 380 and 390 may be implemented as transceivers configured to support wire-based or wireless signal communication. This communication may involve, for example, sending and receiving messages, parameters, and/or other types of information.

In an aspect, the WWAN transceiver 310 and/or the short-range wireless transceiver 320 may form a (wireless) communication interface of the UE 302. Similarly, the WWAN transceiver 350, the short-range wireless transceiver 360, and/or the network interface(s) 380 may form a (wireless) communication interface of the base station 304. Likewise, the network interface(s) 390 may form a (wireless) communication interface of the network entity 306.

The UE 302, the base station 304, and the network entity 306 also include other components that may be used in conjunction with the operations as disclosed herein. The UE 302 includes processor circuitry implementing a processing system 332 for providing functionality relating to, for example, wireless positioning, and for providing other processing functionality. The base station 304 includes a processing system 384 for providing functionality relating to, for example, wireless positioning as disclosed herein, and for providing other processing functionality. The network entity 306 includes a processing system 394 for providing functionality relating to, for example, wireless positioning as disclosed herein, and for providing other processing functionality. The processing systems 332, 384, and 394 may therefore provide means for processing, such as means for determining, means for calculating, means for receiving, means for transmitting, means for indicating, etc. In an aspect, the processing systems 332, 384, and 394 may include, for example, one or more processors, such as one or more general purpose processors, multi-core processors, ASICs, digital signal processors (DSPs), field programmable gate arrays (FPGA), other programmable logic devices or processing circuitry, or various combinations thereof.

The UE 302, the base station 304, and the network entity 306 include memory circuitry implementing memory components 340, 386, and 396 (e.g., each including a memory device), respectively, for maintaining information (e.g., information indicative of reserved resources, thresholds, parameters, and so on). The memory components 340, 386, and 396 may therefore provide means for storing, means for retrieving, means for maintaining, etc. In some cases, the UE 302, the base station 304, and the network entity 306 may include location request modules 342, 388, and 398, respectively. The location request modules 342, 388, and 398 may be hardware circuits that are part of or coupled to the processing systems 332, 384, and 394, respectively, that, when executed, cause the UE 302, the base station 304, and the network entity 306 to perform the functionality described herein. In other aspects, the location request modules 342, 388, and 398 may be external to the processing systems 332, 384, and 394 (e.g., part of a modem processing system, integrated with another processing system, etc.). Alternatively, the location request modules 342, 388, and 398 may be memory modules stored in the memory components 340, 386, and 396, respectively, that, when executed by the processing systems 332, 384, and 394 (or a modem processing system, another processing system, etc.), cause the UE 302, the base station 304, and the network entity 306 to perform the functionality described herein. FIG. 3A illustrates possible locations of the location request module 342, which may be part of the WWAN transceiver 310, the memory component 340, the processing system 332, or any combination thereof, or may be a standalone component. FIG. 3B illustrates possible locations of the location request module 388, which may be part of the WWAN transceiver 350, the memory component 386, the processing system 384, or any combination thereof, or may be a standalone component. FIG. 3C illustrates possible locations of the location request module 398, which may be part of the network interface(s) 390, the memory component 396, the processing system 394, or any combination thereof, or may be a standalone component.

The UE 302 may include one or more sensors 344 coupled to the processing system 332 to provide means for sensing or detecting movement and/or orientation information that is independent of motion data derived from signals received by the WWAN transceiver 310, the short-range wireless transceiver 320, and/or the SPS receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in 2D and/or 3D coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the processing system 384 in more detail, in the downlink, IP packets from the network entity 306 may be provided to the processing system 384. The processing system 384 may implement functionality for an RRC layer, a packet data convergence protocol (PDCP) layer, a radio link control (RLC) layer, and a medium access control (MAC) layer. The processing system 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the processing system 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the processing system 332, which implements Layer-3 (L3) and Layer-2 (L2) functionality.

In the uplink, the processing system 332 provides demultiplexing between transport and logical channels, packet reassembly, deciphering, header decompression, and control signal processing to recover IP packets from the core network. The processing system 332 is also responsible for error detection.

Similar to the functionality described in connection with the downlink transmission by the base station 304, the processing system 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARD), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the processing system 384.

In the uplink, the processing system 384 provides demultiplexing between transport and logical channels, packet reassembly, deciphering, header decompression, control signal processing to recover IP packets from the UE 302. IP packets from the processing system 384 may be provided to the core network. The processing system 384 is also responsible for error detection.

For convenience, the UE 302, the base station 304, and/or the network entity 306 are shown in FIGS. 3A to 3C as including various components that may be configured according to the various examples described herein. It will be appreciated, however, that the illustrated blocks may have different functionality in different designs.

The various components of the UE 302, the base station 304, and the network entity 306 may communicate with each other over data buses 334, 382, and 392, respectively. In an aspect, the data buses 334, 382, and 392 may form, or be part of, the communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A to 3C may be implemented in various ways. In some implementations, the components of FIGS. 3A to 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processing systems 332, 384, 394, the transceivers 310, 320, 350, and 360, the memory components 340, 386, and 396, the location request modules 342, 388, and 398, etc.

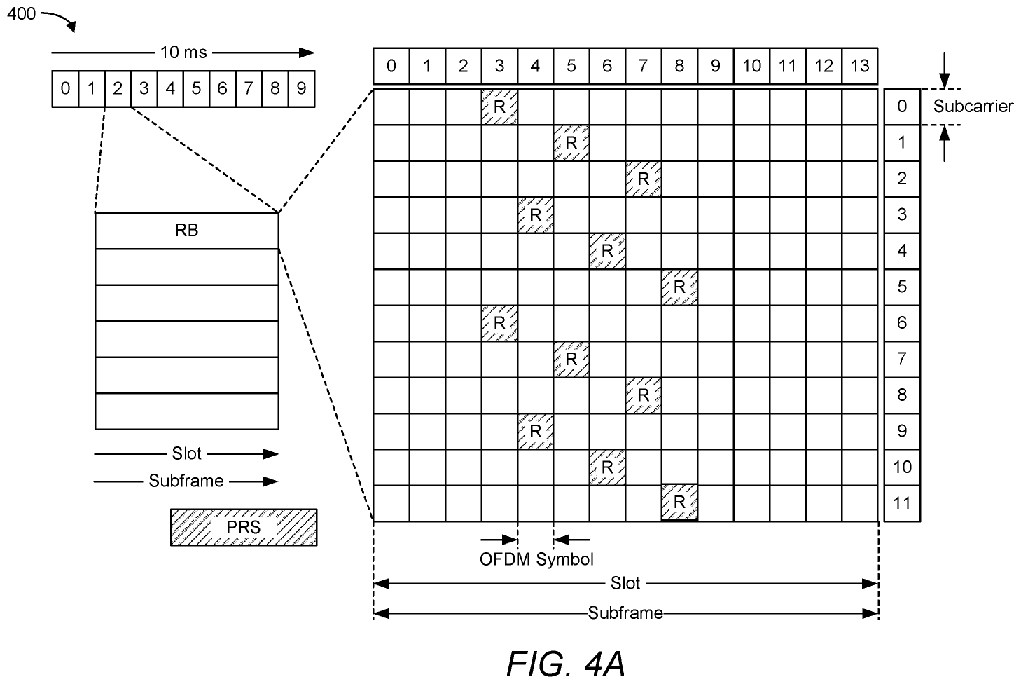

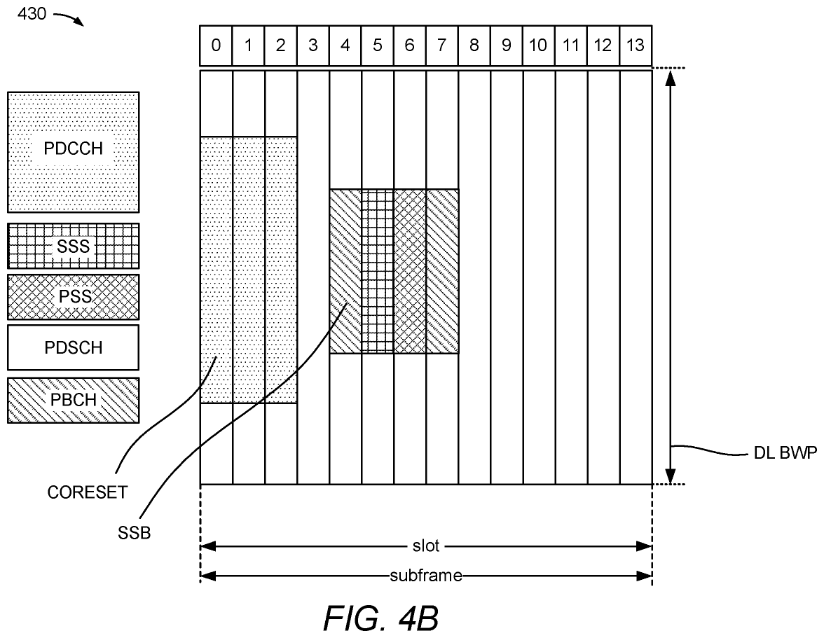

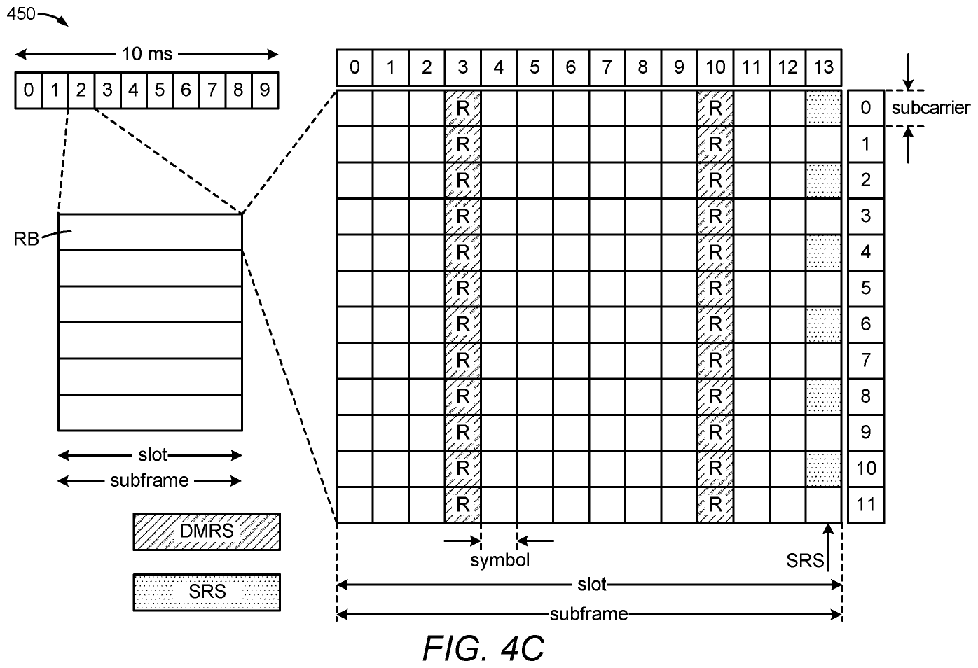

FIGS. 4A to 4D are diagrams illustrating example frame structures and channels within the frame structures, according to aspects of the disclosure.

Various frame structures may be used to support downlink and uplink transmissions between network nodes (e.g., base stations and UEs). FIG. 4A is a diagram 400 illustrating an example of a downlink frame structure, according to aspects of the disclosure. FIG. 4B is a diagram 430 illustrating an example of channels within the downlink frame structure, according to aspects of the disclosure. FIG. 4C is a diagram 450 illustrating an example of an uplink frame structure, according to aspects of the disclosure. FIG. 4D is a diagram 480 illustrating an example of channels within an uplink frame structure, according to aspects of the disclosure. Other wireless communications technologies may have different frame structures and/or different channels.

LTE, and in some cases NR, utilizes OFDM on the downlink and single-carrier frequency division multiplexing (SC-FDM) on the uplink. Unlike LTE, however, NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kilohertz (kHz) and the minimum resource allocation (resource block) may be 12 subcarriers (or 180 kHz). Consequently, the nominal FFT size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing (SCS), symbol length, etc.). In contrast, NR may support multiple numerologies (μ), for example, subcarrier spacings of 15 kHz (μ=0), 30 kHz (μ=1), 60 kHz (μ=2), 120 kHz (μ=3), and 240 kHz (μ=4) or greater may be available. In each subcarrier spacing, there are 14 symbols per slot. For 15 kHz SCS (μ=0), there is one slot per subframe, 10 slots per frame, the slot duration is 1 millisecond (ms), the symbol duration is 66.7 microseconds (μs), and the maximum nominal system bandwidth (in MHz) with a 4K FFT size is 50. For 30 kHz SCS (μ=1), there are two slots per subframe, 20 slots per frame, the slot duration is 0.5 ms, the symbol duration is 33.3 μs, and the maximum nominal system bandwidth (in MHz) with a 4K FFT size is 100. For 60 kHz SCS (v2), there are four slots per subframe, 40 slots per frame, the slot duration is 0.25 ms, the symbol duration is 16.7 μs, and the maximum nominal system bandwidth (in MHz) with a 4K FFT size is 200. For 120 kHz SCS (μ=3), there are eight slots per subframe, 80 slots per frame, the slot duration is 0.125 ms, the symbol duration is 8.33 μs, and the maximum nominal system bandwidth (in MHz) with a 4K FFT size is 400. For 240 kHz SCS (μ=4), there are 16 slots per subframe, 160 slots per frame, the slot duration is 0.0625 ms, the symbol duration is 4.17 μs, and the maximum nominal system bandwidth (in MHz) with a 4K FFT size is 800.

In the example of FIGS. 4A to 4D, a numerology of 15 kHz is used. Thus, in the time domain, a 10 ms frame is divided into 10 equally sized subframes of 1 ms each, and each subframe includes one time slot. In FIGS. 4A to 4D, time is represented horizontally (on the X axis) with time increasing from left to right, while frequency is represented vertically (on the Y axis) with frequency increasing (or decreasing) from bottom to top.

A resource grid may be used to represent time slots, each time slot including one or more time-concurrent resource blocks (RBs) (also referred to as physical RBs (PRBs)) in the frequency domain. The resource grid is further divided into multiple resource elements (REs). An RE may correspond to one symbol length in the time domain and one subcarrier in the frequency domain. In the numerology of FIGS. 4A to 4D, for a normal cyclic prefix, an RB may contain 12 consecutive subcarriers in the frequency domain and seven consecutive symbols in the time domain, for a total of 84 REs. For an extended cyclic prefix, an RB may contain 12 consecutive subcarriers in the frequency domain and six consecutive symbols in the time domain, for a total of 72 REs. The number of bits carried by each RE depends on the modulation scheme.

Some of the REs carry downlink reference (pilot) signals (DL-RS). The DL-RS may include PRS, TRS, PTRS, CRS, CSI-RS, DMRS, PSS, SSS, SSB, etc. FIG. 4A illustrates example locations of REs carrying PRS (labeled “R”).

A collection of resource elements (REs) that are used for transmission of PRS is referred to as a “PRS resource.” The collection of resource elements can span multiple PRBs in the frequency domain and ‘N’ (such as 1 or more) consecutive symbol(s) within a slot in the time domain. In a given OFDM symbol in the time domain, a PRS resource occupies consecutive PRBs in the frequency domain.

The transmission of a PRS resource within a given PRB has a particular comb size (also referred to as the “comb density”). A comb size ‘N’ represents the subcarrier spacing (or frequency/tone spacing) within each symbol of a PRS resource configuration. Specifically, for a comb size ‘N,’ PRS are transmitted in every Nth subcarrier of a symbol of a PRB. For example, for comb-4, for each symbol of the PRS resource configuration, REs corresponding to every fourth subcarrier (such as subcarriers 0, 4, 8) are used to transmit PRS of the PRS resource. Currently, comb sizes of comb-2, comb-4, comb-6, and comb-12 are supported for DL-PRS. FIG. 4A illustrates an example PRS resource configuration for comb-6 (which spans six symbols). That is, the locations of the shaded REs (labeled “R”) indicate a comb-6 PRS resource configuration.

Currently, a DL-PRS resource may span 2, 4, 6, or 12 consecutive symbols within a slot with a fully frequency-domain staggered pattern. A DL-PRS resource can be configured in any higher layer configured downlink or flexible (FL) symbol of a slot. There may be a constant energy per resource element (EPRE) for all REs of a given DL-PRS resource. The following are the frequency offsets from symbol to symbol for comb sizes 2, 4, 6, and 12 over 2, 4, 6, and 12 symbols. 2-symbol comb-2: {0, 1}; 4-symbol comb-2: {0, 1, 0, 1}; 6-symbol comb-2: {0, 1, 0, 1, 0, 1}; 12-symbol comb-2: {0, 1, 0, 1, 0, 1, 0, 1, 0, 1, 0, 1}; 4-symbol comb-4: {0, 2, 1, 3}; 12-symbol comb-4: {0, 2, 1, 3, 0, 2, 1, 3, 0, 2, 1, 3}; 6-symbol comb-6: {0, 3, 1, 4, 2, 5}; 12-symbol comb-6: {0, 3, 1, 4, 2, 5, 0, 3, 1, 4, 2, 5}; and 12-symbol comb-12: {0, 6, 3, 9, 1, 7, 4, 10, 2, 8, 5, 11}.

A “PRS resource set” is a set of PRS resources used for the transmission of PRS signals, where each PRS resource has a PRS resource ID. In addition, the PRS resources in a PRS resource set are associated with the same TRP. A PRS resource set is identified by a PRS resource set ID and is associated with a particular TRP (identified by a TRP ID). In addition, the PRS resources in a PRS resource set have the same periodicity, a common muting pattern configuration, and the same repetition factor (such as “PRS-ResourceRepetitionFactor”) across slots. The periodicity is the time from the first repetition of the first PRS resource of a first PRS instance to the same first repetition of the same first PRS resource of the next PRS instance. The periodicity may have a length selected from 2\hat{ }μ*{4, 5, 8, 10, 16, 20, 32, 40, 64, 80, 160, 320, 640, 1280, 2560, 5120, 10240} slots, with μ=0, 1, 2, 3. The repetition factor may have a length selected from {1, 2, 4, 6, 8, 16, 32} slots.

A PRS resource ID in a PRS resource set is associated with a single beam (or beam ID) transmitted from a single TRP (where a TRP may transmit one or more beams). That is, each PRS resource of a PRS resource set may be transmitted on a different beam, and as such, a “PRS resource,” or simply “resource,” also can be referred to as a “beam.” Note that this does not have any implications on whether the TRPs and the beams on which PRS are transmitted are known to the UE.

A “PRS instance” or “PRS occasion” is one instance of a periodically repeated time window (such as a group of one or more consecutive slots) where PRS are expected to be transmitted. A PRS occasion also may be referred to as a “PRS positioning occasion,” a “PRS positioning instance, a “positioning occasion,” “a positioning instance,” a “positioning repetition,” or simply an “occasion,” an “instance,” or a “repetition.”

A “positioning frequency layer” (also referred to simply as a “frequency layer”) is a collection of one or more PRS resource sets across one or more TRPs that have the same values for certain parameters. Specifically, the collection of PRS resource sets has the same subcarrier spacing and cyclic prefix (CP) type (meaning all numerologies supported for the PDSCH are also supported for PRS), the same Point A, the same value of the downlink PRS bandwidth, the same start PRB (and center frequency), and the same comb-size. The Point A parameter takes the value of the parameter “ARFCN-ValueNR” (where “ARFCN” stands for “absolute radio-frequency channel number”) and is an identifier/code that specifies a pair of physical radio channel used for transmission and reception. The downlink PRS bandwidth may have a granularity of four PRBs, with a minimum of 24 PRBs and a maximum of 272 PRBs. Currently, up to four frequency layers have been defined, and up to two PRS resource sets may be configured per TRP per frequency layer.

The concept of a frequency layer is somewhat like the concept of component carriers and bandwidth parts (BWPs), but different in that component carriers and BWPs are used by one base station (or a macro cell base station and a small cell base station) to transmit data channels, while frequency layers are used by several (usually three or more) base stations to transmit PRS. A UE may indicate the number of frequency layers it can support when it sends the network its positioning capabilities, such as during an LTE positioning protocol (LPP) session. For example, a UE may indicate whether it can support one or four positioning frequency layers.

FIG. 4B illustrates an example of various channels within a downlink slot of a radio frame. In NR, the channel bandwidth, or system bandwidth, is divided into multiple BWPs. A BWP is a contiguous set of PRBs selected from a contiguous subset of the common RBs for a given numerology on a given carrier. Generally, a maximum of four BWPs can be specified in the downlink and uplink. That is, a UE can be configured with up to four BWPs on the downlink, and up to four BWPs on the uplink. Only one BWP (uplink or downlink) may be active at a given time, meaning the UE may only receive or transmit over one BWP at a time. On the downlink, the bandwidth of each BWP should be equal to or greater than the bandwidth of the SSB, but it may or may not contain the SSB.

Referring to FIG. 4B, a primary synchronization signal (PSS) is used by a UE to determine subframe/symbol timing and a physical layer identity. A secondary synchronization signal (SSS) is used by a UE to determine a physical layer cell identity group number and radio frame timing. Based on the physical layer identity and the physical layer cell identity group number, the UE can determine a PCI. Based on the PCI, the UE can determine the locations of the aforementioned DL-RS. The physical broadcast channel (PBCH), which carries an MIB, may be logically grouped with the PSS and SSS to form an SSB (also referred to as an SS/PBCH). The MIB provides a number of RBs in the downlink system bandwidth and a system frame number (SFN). The physical downlink shared channel (PDSCH) carries user data, broadcast system information not transmitted through the PBCH, such as system information blocks (SIBs), and paging messages.

The physical downlink control channel (PDCCH) carries downlink control information (DCI) within one or more control channel elements (CCEs), each CCE including one or more RE group (REG) bundles (which may span multiple symbols in the time domain), each REG bundle including one or more REGs, each REG corresponding to 12 resource elements (one resource block) in the frequency domain and one OFDM symbol in the time domain. The set of physical resources used to carry the PDCCH/DCI is referred to in NR as the control resource set (CORESET). In NR, a PDCCH is confined to a single CORESET and is transmitted with its own DMRS. This enables UE-specific beamforming for the PDCCH.

In the example of FIG. 4B, there is one CORESET per BWP, and the CORESET spans three symbols (although it may be only one or two symbols) in the time domain. Unlike LTE control channels, which occupy the entire system bandwidth, in NR, PDCCH channels are localized to a specific region in the frequency domain (i.e., a CORESET). Thus, the frequency component of the PDCCH shown in FIG. 4B is illustrated as less than a single BWP in the frequency domain. Note that although the illustrated CORESET is contiguous in the frequency domain, it need not be. In addition, the CORESET may span less than three symbols in the time domain.

The DCI within the PDCCH carries information about uplink resource allocation (persistent and non-persistent) and descriptions about downlink data transmitted to the UE, referred to as uplink and downlink grants, respectively. More specifically, the DCI indicates the resources scheduled for the downlink data channel (e.g., PDSCH) and the uplink data channel (e.g., PUSCH). Multiple (e.g., up to eight) DCIs can be configured in the PDCCH, and these DCIs can have one of multiple formats. For example, there are different DCI formats for uplink scheduling, for downlink scheduling, for uplink transmit power control (TPC), etc. A PDCCH may be transported by 1, 2, 4, 8, or 16 CCEs in order to accommodate different DCI payload sizes or coding rates.

As illustrated in FIG. 4C, some of the REs (labeled “R”) carry DMRS for channel estimation at the receiver (e.g., a base station, another UE, etc.). A UE may additionally transmit SRS in, for example, the last symbol of a slot. The SRS may have a comb structure, and a UE may transmit SRS on one of the combs. In the example of FIG. 4C, the illustrated SRS is comb-2 over one symbol. The SRS may be used by a base station to obtain the channel state information (CSI) for each UE. CSI describes how an RF signal propagates from the UE to the base station and represents the combined effect of scattering, fading, and power decay with distance. The system uses the SRS for resource scheduling, link adaptation, massive MIMO, beam management, etc.

Currently, an SRS resource may span 1, 2, 4, 8, or 12 consecutive symbols within a slot with a comb size of comb-2, comb-4, or comb-8. The following are the frequency offsets from symbol to symbol for the SRS comb patterns that are currently supported. 1-symbol comb-2: {0}; 2-symbol comb-2: {0, 1}; 4-symbol comb-2: {0, 1, 0, 1}; 4-symbol comb-4: {0, 2, 1, 3}; 8-symbol comb-4: {0, 2, 1, 3, 0, 2, 1, 3}; 12-symbol comb-4: {0, 2, 1, 3, 0, 2, 1, 3, 0, 2, 1, 3}; 4-symbol comb-8: {0, 4, 2, 6}; 8-symbol comb-8: {0, 4, 2, 6, 1, 5, 3, 7}; and 12-symbol comb-8: {0, 4, 2, 6, 1, 5, 3, 7, 0, 4, 2, 6}.

A collection of resource elements that are used for transmission of SRS is referred to as an “SRS resource,” and may be identified by the parameter “SRS-ResourceId.” The collection of resource elements can span multiple PRBs in the frequency domain and N (e.g., one or more) consecutive symbol(s) within a slot in the time domain. In a given OFDM symbol, an SRS resource occupies consecutive PRBs. An “SRS resource set” is a set of SRS resources used for the transmission of SRS signals, and is identified by an SRS resource set ID (“SRS-ResourceSetId”).

Generally, a UE transmits SRS to enable the receiving base station (either the serving base station or a neighboring base station) to measure the channel quality between the UE and the base station. However, SRS can also be specifically configured as uplink positioning reference signals for uplink-based positioning procedures, such as uplink time difference of arrival (UL-TDOA), round-trip-time (RTT), uplink angle-of-arrival (UL-AoA), etc. As used herein, the term “SRS” may refer to SRS configured for channel quality measurements or SRS configured for positioning purposes. The former may be referred to herein as “SRS-for-communication” and/or the latter may be referred to as “SRS-for-positioning” when needed to distinguish the two types of SRS.

Several enhancements over the previous definition of SRS have been proposed for SRS-for-positioning (also referred to as “UL-PRS”), such as a new staggered pattern within an SRS resource (except for single-symbol/comb-2), a new comb type for SRS, new sequences for SRS, a higher number of SRS resource sets per component carrier, and a higher number of SRS resources per component carrier. In addition, the parameters “SpatialRelationInfo” and “PathLossReference” are to be configured based on a downlink reference signal or SSB from a neighboring TRP. Further still, one SRS resource may be transmitted outside the active BWP, and one SRS resource may span across multiple component carriers. Also, SRS may be configured in RRC connected state and only transmitted within an active BWP. Further, there may be no frequency hopping, no repetition factor, a single antenna port, and new lengths for SRS (e.g., 8 and 12 symbols). There also may be open-loop power control and not closed-loop power control, and comb-8 (i.e., an SRS transmitted every eighth subcarrier in the same symbol) may be used. Lastly, the UE may transmit through the same transmit beam from multiple SRS resources for UL-AoA. All of these are features that are additional to the current SRS framework, which is configured through RRC higher layer signaling (and potentially triggered or activated through MAC control element (CE) or DCI).

FIG. 4D illustrates an example of various channels within an uplink slot of a frame, according to aspects of the disclosure. A random-access channel (RACH), also referred to as a physical random-access channel (PRACH), may be within one or more slots within a frame based on the PRACH configuration. The PRACH may include six consecutive RB pairs within a slot. The PRACH allows the UE to perform initial system access and achieve uplink synchronization. A physical uplink control channel (PUCCH) may be located on edges of the uplink system bandwidth. The PUCCH carries uplink control information (UCI), such as scheduling requests, CSI reports, a channel quality indicator (CQI), a precoding matrix indicator (PMI), a rank indicator (RI), and HARQ ACK/NACK feedback. The physical uplink shared channel (PUSCH) carries data, and may additionally be used to carry a buffer status report (BSR), a power headroom report (PHR), and/or UCI.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. If needed to further distinguish the type of PRS, a downlink positioning reference signal may be referred to as a “DL-PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.”

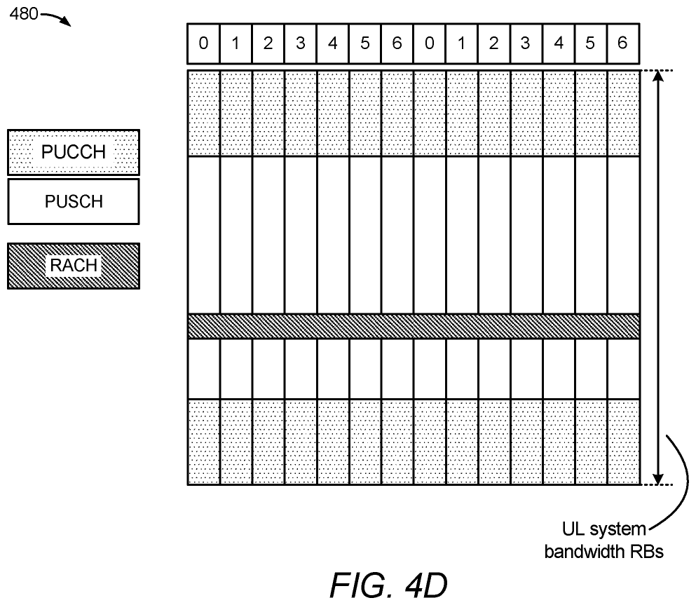

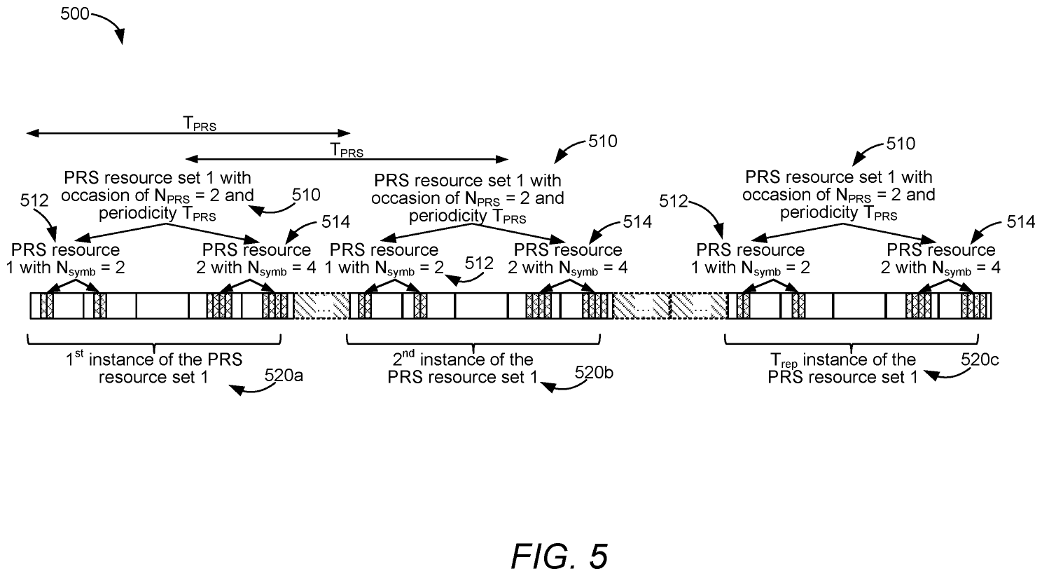

FIG. 5 is a diagram of an example PRS configuration 500 for the PRS transmissions of a given base station, according to aspects of the disclosure. In FIG. 5, time is represented horizontally, increasing from left to right. Each long rectangle represents a slot and each short (shaded) rectangle represents an OFDM symbol. In the example of FIG. 5, a PRS resource set 510 (labeled “PRS resource set 1”) includes two PRS resources, a first PRS resource 512 (labeled “PRS resource 1”) and a second PRS resource 514 (labeled “PRS resource 2”). The base station transmits PRS on the PRS resources 512 and 514 of the PRS resource set 510.

The PRS resource set 510 has an occasion length (N_PRS) of two slots and a periodicity (T_PRS) of, for example, 160 slots or 160 milliseconds (ms) (for 15 kHz subcarrier spacing). As such, both the PRS resources 512 and 514 are two consecutive slots in length and repeat every T_PRS slots, starting from the slot in which the first symbol of the respective PRS resource occurs. In the example of FIG. 5, the PRS resource 512 has a symbol length (N_symb) of two symbols, and the PRS resource 514 has a symbol length (N_symb) of four symbols. The PRS resource 512 and the PRS resource 514 may be transmitted on separate beams of the same base station.

Each instance of the PRS resource set 510, illustrated as instances 520a, 520b, and 520c, includes an occasion of length ‘2’ (i.e., N_PRS=2) for each PRS resource 512, 514 of the PRS resource set. The PRS resources 512 and 514 are repeated every T_PRS slots up to the muting sequence periodicity T_REP. As such, a bitmap of length T_REP would be needed to indicate which occasions of instances 520a, 520b, and 520c of PRS resource set 510 are muted (i.e., not transmitted).

In an aspect, there may be additional constraints on the PRS configuration 500. For example, for all PRS resources (e.g., PRS resources 512, 514) of a PRS resource set (e.g., PRS resource set 510), the base station can configure the following parameters to be the same: (a) the occasion length (T_PRS), (b) the number of symbols (N_symb), (c) the comb type, and/or (d) the bandwidth. In addition, for all PRS resources of all PRS resource sets, the subcarrier spacing, and the cyclic prefix can be configured to be the same for one base station or for all base stations. Whether it is for one base station or all base stations may depend on the UE's capability to support the first and/or second option.

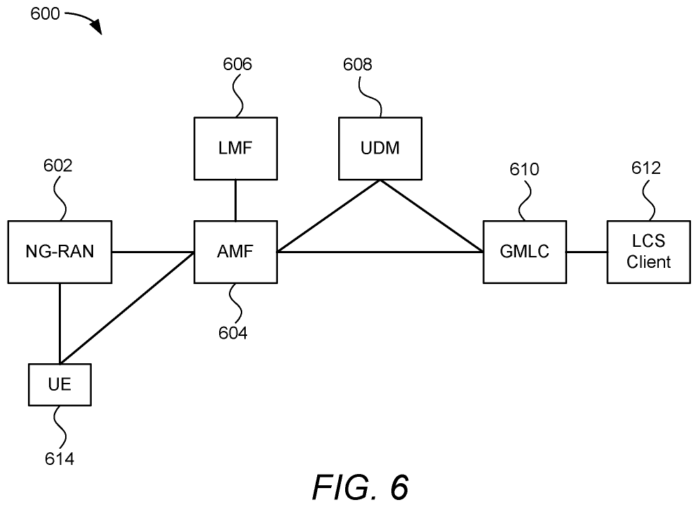

FIG. 6 is a diagram showing an architecture reference model 600 for location services. The model 600 is for a non-roaming scenario within a fifth-generation core (5GC) and shows the logical connections between the following nodes: a next-generation radio access network (NG-RAN) 602 (e.g., BS 102); an access and mobility management function (AMF) 604 for managing UE registration and paging; a location management function (LMF) 606 for supporting location determination for a UE; a unified data management function (UDM) 608 for managing network user data in a single, centralized element; a 5GC gateway mobile location center (GMLC) 610 for receiving and processing request from a location services (LCS) client 612. In FIG. 6, the NG-RAN 602 is serving a UE 614 (e.g., UE 104).

Conceptually, location determination may consist of two phases: a location preparation phase and a location execution phase. In the location preparation phase, one or more nodes signal to one or more other nodes to arrange conditions for measurements to happen. This phase can include requests for measurement, requests for and provision of PRS configurations, etc., and may involve a location server, such as LMF 606, a base station, such as an NR NodeB (referred to as a gNB) which may be part of NG-RAN 602, a UE 614, an LCS client 612, a GMLC 610, or other network nodes. It is noted that there is a latency involved in the transmission of such requests across the network, which may include signaling propagation and transmission delays, processing delays by each node in the path, and delays due to network traffic and/or internal node queueing. In the location execution phase, the measurements are obtained by the UE 614 and/or by other nodes such as nodes in NG-RAN 602, are optionally reported by the UE 614 and/or by the other nodes to another node such as LMF 606, and a position is computed based on those measurements. The position may be computed by the UE 614 (e.g., in UE-based positioning) or by another node such as LMF 606 (e.g., in UE-assisted positioning). Subsequently, and as a final part of the location execution phase, the computed position may be transferred to the LCS Client 612 or to the UE 614 (e.g. may be transferred to an App on the UE 614).

A location request sent to a network (e.g. to a GMLC 610 or LMF 606) by an LCS Client 612 may be associated with a response time quality of service (QoS) attribute. For immediate location requests, response time options can be as follows:
“no delay”: the network should immediately return any location that it currently has. If no location estimate is available, the network shall return a failure indication.
“low delay”: fulfilment of a location response time requirement (e.g. a low location response time requirement of a few seconds) takes precedence over fulfilment of a location accuracy requirement. The network shall return a current location of the target UE 614 with minimum delay. The network shall also attempt to fulfill any location accuracy requirement, but in doing so shall not add any additional delay (i.e. a quick location response with lower accuracy is more desirable than waiting for a more accurate location response).
“delay tolerant”: fulfilment of a location accuracy requirement takes precedence over fulfilment of a location response time requirement. If necessary, the network should delay providing a location response until the location accuracy requirement of the requesting application (e.g. LCS Client 612) is met. The network shall obtain a current location with regard to fulfilling the location accuracy requirement.

There are situations where a UE 614's location must be known as some time in the future.

These are referred to as scheduled location requests to distinguish them from immediate location requests. A node (e.g. LMF 606) may be provided with a one-shot request for the location of a UE 614 at some future time T or a periodic location request with the first occurrence at some future time T, for example. Use cases include, but are not limited to, industrial internet of things (IIoT) applications, vehicle to anything (V2X) applications, asset-tracking applications, and others.

A first network node, such as the GMLC 610 desiring to make a scheduling request for a UE 614's location at a future time T may defer making the request to a second network node, such as a visited GMLC (not shown in FIG. 6), e.g., if the UE 614 is roaming, or the AMF 604, e.g., if the UE 614 is in the home network, so that the second network node does not have to schedule the location request into the future. For example, if Tlatency is a predicted time period for the second node to perform a portion of the location preparation phase controlled by the second node, then the first network node may defer sending the location request to the second network node until time (T−Tlatency). The second network node has an amount of time Tlatency to perform the location preparation phase so that the location measurements can be obtained at time T and the location of UE 614 can then be reported back to the first network node just after time T as part of the location execution phase. This approach has the disadvantage that it requires the first network node to estimate the second network node's Tlatency time period and to coordinate its signaling to the second network node accordingly.

Regarding response QoS, the “no delay” option may be deemed incompatible for scheduled location requests, because the “no delay” option means that there should be an immediate location response with a UE 614 location that is already available, and a scheduled request is a request for a location at some future time T1 (and is thus not immediately available at the time of the request T0). Thus, there may be no support for a “no delay” option for scheduled location requests.

To address this deficiency, the present disclosure presents methods and systems for providing a no delay response QoS for scheduled location requests. A scheduled location request with a response QoS attribute set to “no delay” is herein referred to as a “no delay scheduled location request.”

The techniques disclosed herein recognize the fact that a situation may arise where, at a time T0, there is a scheduled location request (e.g. sent by LCS Client 612) for the location of a node (e.g. a UE 614) at some future time T1, and where the location of the node is not known at time T0 but may become known and available at some future time T2, where time T2 occurs before time T1 (e.g. T2<T1). Thus, at time T1, a “no delay” response may be possible, i.e., the location request sent at time T0 may be fulfilled immediately at time T1 with no delay by reporting the location that was determined at the prior time T2, and no measurements are needed at time T1. In this manner, at time T1, a network node (e.g. LMF 606 or UE 614) behaves as if it had received an immediate location request with no delay at time T1, even though it had actually received, at time T0, a scheduled location request with no delay for time T1.

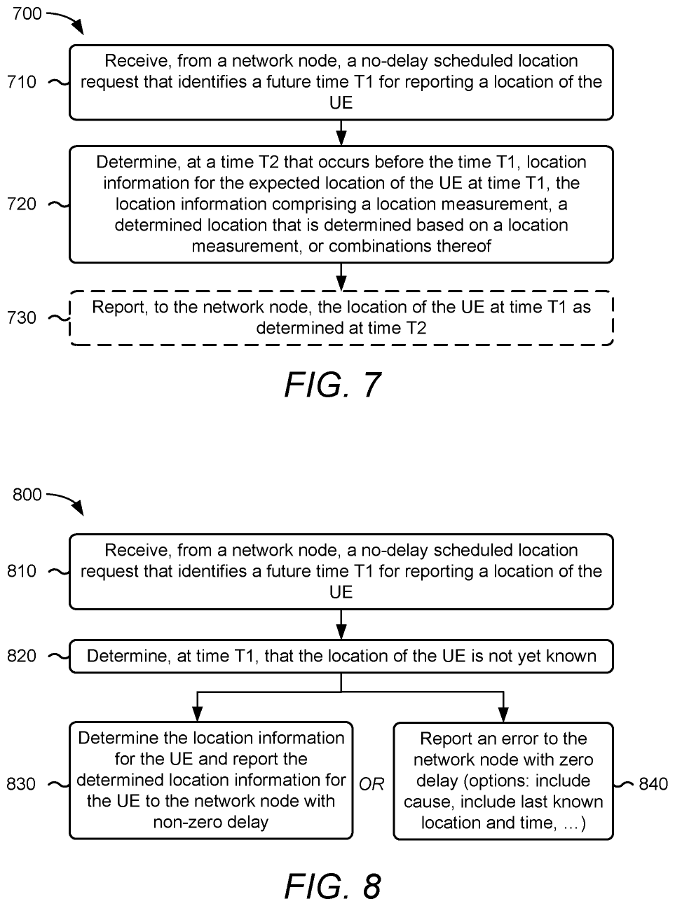

FIG. 7 is a flowchart of an example process 700 associated with a no-delay scheduled location request for a UE (e.g. UE 104 or UE 614) according to some aspects. In some aspects, one or more process blocks of FIG. 7 may be performed by the UE, by an LMF (e.g. LMF 606) or by a GMLC (e.g. GMLC 610). Additionally, or alternatively, one or more process blocks of FIG. 7 may be performed by one or more components of device 302, such as processing system 332, WWAN transceiver 310, short-range wireless transceiver 320, SPS receiver 330, location request module(s) 342, and user interface 346, any or all of which may be considered means for performing this operation.

As shown in FIG. 7, process 700 may include receiving, from a network node (e.g. an LMF 606 or a GMLC 610), a no-delay scheduled location request that identifies a future time T1 for reporting a location of the UE (block 710). Means for performing the operation of block 710 may include the WWAN transceiver 310 and the processing system 332 of the UE 302. For example, the UE 302 may receive, via receiver(s) 312, a no-delay scheduled location request that identifies a future time T1 for reporting a location of the UE. In some aspects, the no-delay scheduled location request comprises a scheduled location request having a response quality of service (QoS) attribute indicating no delay.

As further shown in FIG. 7, process 700 may include determining, at a time T2, where time T2 occurs before time T1 (e.g. T2<T1), location information for the expected location of the UE at time T1 (block 720), which is referred to herein as “location information of the UE 302 at time T1” (even though determined at time T2). Means for performing the operation of block 720 may include the processing system 332 of the UE 302. For example, at time T2, the location request module(s) 342 of the UE 302 may determine location information associated with the expected location of the UE 302 at time T1. The location information may comprise a location measurement, a determined location that is determined based on the location measurement, or combinations thereof. In some aspects, at time T2, the determined location of the UE 304 may be its actual location at time T2, which is expected to also be its location at time T1. In some aspects, at time T2, the determined location of the UE 302 at time T1 may be a predicted or anticipated location of the UE 302 at time T1 (e.g. based on a location of the UE at time T2 and a velocity of the UE at time T2).

As further shown in FIG. 7, process 700 may optionally include reporting, to the network node, the location information for the UE at time T1 as determined at time T2 (block 730). Means for performing the operation of block 730 may include the WWAN transceiver 310 and the processing system 332 of the UE 302. For example, the UE 302 may transmit, via transmitter(s) 314, the location of the UE 302 at time T1 as determined by the location request module(s) 342. In some aspects, the location information for the UE at time T1 is reported to the network node at time T1. For example, the UE 302 may wait until time T1 to report its location information to the network node, even when it knows the location information at time T2. In some aspects, the location information for the UE at time T1 is reported to the network node before time T1. For example, the location information may be reported to the network node at some time between time T2 and time T1.

Alternatively, when process 700 is performed by the UE, rather than reporting its location information, the UE may instead use the location information internally. For example, an application hosted by the UE may require that it know the UE's position at some future time T1, and communicate this to a network node, which in turn generates the no-delay scheduled location request. Upon determining a location of the UE at time T1, this information may be provided to the application within the UE and not forwarded to a network node.

Process 700 may include additional aspects, such as any single aspect or any combination of aspects described below and/or in connection with one or more other processes described elsewhere herein. Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a flowchart of an example process 800 associated with a no-delay scheduled location request according to some aspects. In some aspects, one or more process blocks of FIG. 8 may be performed by a UE (e.g., UE 104, UE 614). In some aspects, one or more process blocks of FIG. 8 may be performed by another device or a group of devices separate from or including the UE, such as an LMF (e.g. LMF 606) or a GMLC (e.g. GMLC 610). Additionally, or alternatively, one or more process blocks of FIG. 8 may be performed by one or more components of device 302, such as processing system 332, WWAN transceiver 310, short-range wireless transceiver 320, SPS receiver 330, location request module(s) 342, and user interface 346, any or all of which may be considered means for performing this operation.

As shown in FIG. 8, process 800 may include receiving, from a network node, a no-delay scheduled location request that identifies a future time TI for reporting a location of the UE (block 810). Means for performing the operation of block 810 may include the WWAN transceiver 310 and the processing system 332 of the UE 302. For example, the UE 302 may receive, via receiver(s) 312, a no-delay scheduled location request that identifies a future time T1 for reporting a location of the UE. In some aspects, the no-delay scheduled location request comprises a scheduled location request having a response quality of service (QoS) attribute indicating no delay.

As further shown in FIG. 8, process 800 may include determining, at time T1, that the location of the UE is not yet known (block 820). Means for performing the operation of block 820 may include the WWAN transceiver 310 and the processing system 332 of the UE 302. For example, at time T1, the location request module(s) 342 of the UE 302 may determine that location information for the UE is not yet known, e.g., because a location execution phase was not completed before time T1, because the UE 302 was anticipating arriving at a charging station or other known location but was unable to do so or prevented from doing so, and so on.

As further shown in FIG. 8, process 800 may include either determining location information for the UE, the location information comprising a location measurement, a determined location that is determined based on a location measurement, or combinations thereof, and reporting the location information for the UE to the network node with non-zero delay (block 830), or reporting an error to the network node with zero delay (block 840). Means for performing the operation of block 830 may include the WWAN transceiver 310 and the processing system 332 of the UE 302.

For example, the processing system 332 of the UE 302 may determine the location of the UE 302 using location procedures and transmit, via transmitter(s) 314, its location to network node. Likewise, the UE 302 may take location measurements and report those measurements to the network node, which will use those measurements to estimate the location of UE 302. Since this option involves the UE performing or completing an in-progress location operation, this involves some non-zero delay.

Alternatively, the UE 302 may transmit, via transmitter(s) 314, an error message to the network node with zero delay. In some aspects, the UE 302 may also provide some information indicating the cause of the error (e.g., physical impairment preventing arrival at a predicted location, network delay preventing completion of an earlier-scheduled location operation, etc.) In some aspects, the UE 302 may also provide its last confirmed location, an optionally, a time (or date and time) at which the UE 302 was known to be at the last confirmed location.

In some aspects, the UE 302 may select between block 830 and block 840 based on a QoS class associated with the UE 302 generally, with the location request specifically, or combinations thereof. For example, in some aspects, the UE 302 determines its location and reports the determined location to the network node with non-zero delay if the QoS class is an assured class, but reports the error to the network with zero delay if the QoS class is a best effort class.

Process 800 may include additional aspects, such as any single aspect or any combination of aspects described below and/or in connection with one or more other processes described elsewhere herein. Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

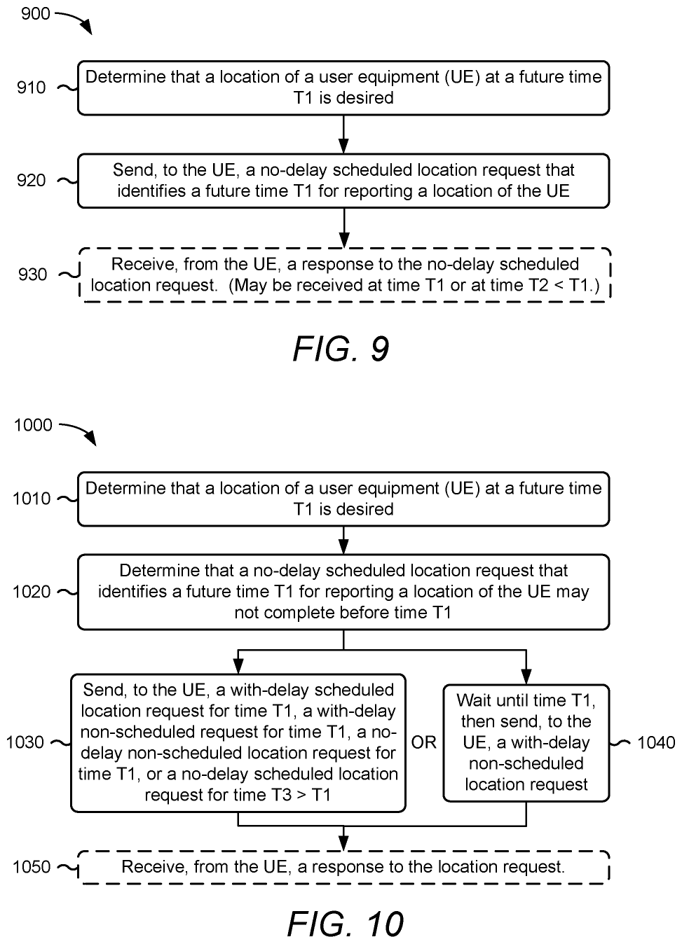

FIG. 9 is a flowchart of an example process 900 associated with a no-delay scheduled location request. In some implementations, one or more process blocks of FIG. 9 may be performed by a network node (e.g., base station 102 or a node in the core network 170). In some implementations, one or more process blocks of FIG. 9 may be performed by another device or a group of devices separate from or including the network node. Additionally, or alternatively, one or more process blocks of FIG. 9 may be performed by one or more components of device 304 or device 306, such as processing system 384 or processing system 394, WWAN transceiver 350, short-range wireless transceiver 360, network interface(s) 390, location request module(s) 388, or location request module(s) 398.

As shown in FIG. 9, process 900 may include determining that a location of a user equipment (UE) at a future time T1 is desired (block 910). Means for performing the operation of block 910 may include the processing system 384 of the base station 304 or the processing system 394 of network node 306. For example, the processing system 394 of the network node 306 may determine that a location of a UE at a future time T1 is desired.

As further shown in FIG. 9, process 900 may include sending, to the UE, a no-delay scheduled location request that identifies a future time T1 for reporting a location of the UE (block 920). Means for performing the operation of block 920 may include the WWAN transceiver 350 and the processing system 384 of base station 304 or the network interface 390 and the processing system 394 of the network node 306. For example, the network node 306 may send the no-delay scheduled location request via the network interface 390, or the base station 304 may send the no-delay scheduled location request via the transmitter(s) 354. In some aspects, the no-delay scheduled location request comprises a scheduled location request having a response quality of service (QoS) attribute indicating no delay. In some aspects, the network node determines that the location of the UE at time T1 is desired and issues the no-delay scheduled location request accordingly. For example, an LMF may make this determination. In some aspects, the UE itself (e.g., an application running on the UE) may require the location of the UE at time T1 and may notify an application server, an LCS client 612, or the GMLC 610, which may trigger the GMLC 610 to issue the no-delay scheduled location request.

As further shown in FIG. 9, process 900 may include receiving, from the UE, a response to the no-delay scheduled location request (block 930), where the response may be received at time T1 or at a time T2 prior to T1. Means for performing the operation of block 930 may include the WWAN transceiver 350 and the processing system 384 of the base station 304 or the network interface 390 and the processing system 394 of the network node 306. For example, the base station 304 may receive the response via the receiver(s) 352 and the network node 306 may receive the response via the network interface 390.

In some aspects the network node may determine that, due to network, transmission, or processing latencies, there may not be enough time for a no-response scheduled location request to complete before time T1. In that scenario, the network node may do one or more of the following:
Issue the scheduled location request that identifies future time T1 as the time for response, but with delay (e.g., without the no-delay option, such as with the low delay or delay tolerant option).
Issue an immediate location request, which may still be completed before time T1, so the “no delay” option may not be required.
Wait until time T1 and issue an immediate location request with delay.

An example of this is shown in FIG. 10.

FIG. 10 is a flowchart of an example process 1000 associated with no-delay scheduled location request. In some implementations, one or more process blocks of FIG. 10 may be performed by a network node (e.g., base station 102 or a node in the core network 170 such as an LMF (e.g. LMF 606)). In some implementations, one or more process blocks of FIG. 10 may be performed by another device or a group of devices separate from or including the network node. Additionally, or alternatively, one or more process blocks of FIG. 10 may be performed by one or more components of device 304 or device 306, such as processing system 384 or processing system 394, WWAN transceiver 350, short-range wireless transceiver 360, network interface(s) 390, location request module(s) 388, or location request module(s) 398.

As shown in FIG. 10, process 1000 may include determining that a location of a user equipment (UE) at a future time T1 is desired (block 1010). Means for performing the operation of block 1010 may include the processing system 384 of the base station 304 or the processing system 394 of network node 306. For example, the processing system 394 of the network node 306 may determine that a location of a UE at a future time T1 is desired.

As further shown in FIG. 10, process 1000 may include determining that a no-delay scheduled location request that identifies the future time T1 for reporting a location of the UE may not complete before time T1 (block 1020). Means for performing the operation of block 1020 may include the processing system 384 of the base station 304 or the processing system 394 of network node 306. For example, the processing system 394 of the network node 306 may determine that a no-delay scheduled location request that identifies the future time T1 for reporting a location of the UE may not complete before time T1. In some aspects, this determination may be made based on knowledge of transmission latencies, node processing latencies, and network or RAN traffic conditions.

As further shown in FIG. 10, process 1000 may include immediately sending, to the UE, a with-delay (e.g., with a low delay or delay tolerant attribute) scheduled or non-scheduled location request for time T1, or a no-delay non-scheduled location request for time T1, a no-delay scheduled location request for a time T3 that occurs after time T1 (block 1030), or, the process may include waiting until time T1, then sending, to the UE, a with-delay non-scheduled location request (block 1040). Means for performing the operation of block 1030 and block 1040 may include the processing system 384 and WWAN transceiver 350 of the base station 304 or the processing system 394 and the network interface 390 of network node 306. For example, the network node 306 may send the chosen type of location request via the network interface 390, or the base station 304 may send the chosen type of location request via the transmitter(s) 354. In some aspects, the selection of the operation of block 1030 may be based at least in part on a QoS class associated with the UE.

As further shown in FIG. 10, process 1000 may include includes receiving, from the UE, a response to the location request (block 1050). Means for performing the operation of block 1050 may include the WWAN transceiver 350 and the processing system 384 of the base station 304 or the network interface 390 and the processing system 394 of the network node 306. For example, the base station 304 may receive the response via the receiver(s) 352 and the network node 306 may receive the response via the network interface 390.

Process 1000 may include additional implementations, such as any single implementation or any combination of implementations described below and/or in connection with one or more other processes described elsewhere herein. Although FIG. 10 shows example blocks of process 1000, in some implementations, process 1000 may include additional blocks, fewer blocks, different blocks, or differently arranged blocks than those depicted in FIG. 10. Additionally, or alternatively, two or more of the blocks of process 1000 may be performed in parallel.

As will be appreciated, a technical advantage of the methods 700, 800, 900, and 1000 is that a scheduled location request can be configured as a no delay request, which obviates the need for the requesting entity to consider current latencies in the network: instead, the requesting entity can issue a no delay scheduled location request to a UE or other node according to the present disclosure. Moreover, the no delay option as described herein can also provide the same benefits to repeated or periodic scheduled location requests without requiring additional signaling for the subsequent scheduled location requests.

The no-delay scheduled location request may be used in a number of use cases, including, but not limited to, the following example involving automated mobile trolleys. Automated mobile trolleys must recharge at periodic intervals, but may choose one of many recharging stations, based on their route plans. A location services (LCS) client knows that the trolley will be recharging at future time T1 but wants to know the location of the specific station the trolley will be using. Thus, at time T0, the trolley receives a no delay scheduled location request for time T1. The trolley itself (e.g. a controlling entity for the trolley) may not know this location at the current time T0, because its route plan may vary depending on events at future times prior to time T1. However, in this example, the trolley will have decided on this location by time T2 that occurs before time T1 and can thus report it with no delay at time T1. In some aspects, the trolley may be configured to wait until time T1 to make the report even though it has the location information at time T2. In other aspects, the trolley may be configured to make the report as soon as it has that information, e.g., at time T2 in this example.

It is important to note that what the trolley is reporting is the location that the trolley is, or predicts to be, at time T1. For example, if, at T2, the trolley has arrived at a location, such as a charging station, and the trolley expects to still be at that location by time T1, then, at time T2, the trolley can report that actual location as the location that the trolley will be at time T1. In another example, if, at T2, the trolley predicts that it will arrive at the charging station by time T1, then, at time T2, the trolley can report that predicted location as the location that the trolley will be at time T1. Of course, if the trolley waits until time T1 to report the location, then by that time the trolley knows whether or not it is at the expected location and if so, can report accordingly.

It is possible that the trolley does not know its location at time T1, for example, because the trolley got stuck or delayed and did not reach the expected location (e.g., the charging station) by time T1. In this scenario, the trolley could take one of several actions, depending on how the trolley is configured. For example, the trolley could, at time T1, be configured to perform the full positioning procedure including measurements and position, although this would not be a ‘no delay’ determination. Another option could be to provide a no delay response, but with an error code or other indication that the location is unknown, and optionally including possible reasons for this. In some aspects, the error message could also include other optional and potentially useful information such as last known location and its time stamp.

In response, the LCS client may then decide to issue another request for the actual location. This may be requested with ‘low delay’ or ‘delay-tolerant’ response time. In some aspects, the options above may be configured, may depend on the LCS QoS class, or combinations thereof. In some aspects, the trolley could proactively report its decided location at any time between T2 and T1, thus fulfilling the location needs of the LCS client even without the need for any location request. However, the LCS client may not always need the location, and the proactive report could be a waste of network resources in the instances when the report was unnecessary. Thus, an ‘on-demand’ scheduled location request may be useful in this scenario.

In some cases, an exact value for T2 may not be known, but an upper-bound T2max for T2 may be known. For example, an LMF or GMLC could determine T2max based on known network latencies, e.g., between GMLC and AMF, between AMF and gNB, between gNB and UE, etc., and also based on processing latencies for each node involved, e.g., the UE, the gNB, the AMF, the GMLC, the LMF, the LCS client, etc. For example, the value of T2max may be different for general UE device versus an IOT device that may be operating in an extended DRX mode or other power saving mode. Moreover, the IIOT device may move along a limited or more scheduled trajectory, so that the gap between T1 and T2 may be larger, whereas a general UE may have an unpredictable trajectory sot that the gap between T1 and T2 may need to be smaller. In some aspects, signaling between the network nodes is provided to enable determination or estimation of the time T2 at which the location is likely to be known in the future.

Eg1. The time gap between T1 and T2 for IIOT device might be different compared with general UE device. (IIOT might be have a more scheduled trajectory so that the gap can be larger, where general UE may have an unpredictable trajectory so that the gap might be small.) Thus, in some aspects, new signaling is provided between the participants, e.g., between the target UE and an LMF.

In some aspects, the choice of scheduled location time T1 may be based on the determined or estimated T2, along with other factors such as signaling overhead and delays. For example, at time T0, an LMF may realize that a UE may not have time to process a no-delay scheduled location request by T1, so the LMF may opt to select a different time for response T1′>T1.

In these scenarios, an effect similar to a no delay scheduled location request could be achieved by sending an immediate location request with ‘no-delay’ option at time T2max. This is true even with the upper-bound T2max=T1, which means that rather than scheduling a ‘no-delay’ location for time T, an alternative is to wait for that time T1 and then send a usual ‘no-delay’ request. Or alternatively, schedule without the ‘no-delay’ option for time T2max<T1. While these may be viable alternatives to a no delay scheduled location request, the no delay scheduled location request has some technical advantages. For example:
The time taken to issue the ‘no-delay’ request may itself be variable (e.g., due to factors like HARQ retransmissions for the message carrying the request). Thus, scheduling ahead of time avoids this variability.
The network may be known to be congested prior to time T. The alternatives involve messaging (request/response) prior to time T, which may be undesirable in this case.
Predictability of when the message arrives may be important in some cases. Some of the alternative proposals involve messages arriving less predictably.
Allowing the ‘no-delay’ option for scheduled location may not cause much additional specification and implementation complexity.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an insulator and a conductor). Furthermore, it is also intended that aspects of a clause can be included in any other independent clause, even if the clause is not directly dependent on the independent clause.

Implementation examples are described in the following numbered clauses:

Clause 1. A method of wireless communication performed by a user equipment (UE), the method comprising: receiving, from a network node, a no-delay scheduled location request that identifies a future time T1 for reporting a location of the UE; and determining, at a time T2 that occurs before time T1, location information for an expected location of the UE at time T1, the location information comprising a location measurement, a determined location that is determined based on a location measurement, or combinations thereof.

Clause 2. The method of clause 1, wherein the no-delay scheduled location request comprises a scheduled location request having a response quality of service (QoS) attribute indicating no delay.

Clause 3. The method of any of clauses 1 to 2, wherein the location information for the expected location of the UE at time T1 comprises the location of the UE at time T2, which the UE predicts will also be its location at time T1.

Clause 4. The method of any of clauses 1 to 3, wherein the location information for the expected location of the UE at time T1 comprises a predicted location for the UE at time T1, which is different from the location of the UE at time T2.

Clause 5. The method of any of clauses 1 to 4, further comprising: reporting, to the network node, the location information for the expected location of the UE at time T1 as determined at time T2.

Clause 6. The method of clause 5, wherein the location information for the expected location of the UE at time T1 is reported to the network node at time T1.

Clause 7. The method of any of clauses 5 to 6, wherein the location information for the expected location of the UE at time T1 is reported to the network node before time T1.

Clause 8. A method of wireless communication performed by a user equipment (UE), the method comprising: receiving, from a network node, a no-delay scheduled location request that identifies a future time T1 for reporting a location of the UE; determining, at time T1, that a location of the UE is not yet known; and either: determining location information for the UE, the location information comprising a location measurement, a determined location that is determined based on a location measurement, or combinations thereof, and reporting the location information for the UE to the network node with non-zero delay; or reporting an error to the network node with zero delay.

Clause 9. The method of clause 8, wherein the no-delay scheduled location request comprises a scheduled location request having a response quality of service (QoS) attribute indicating no delay.

Clause 10. The method of any of clauses 8 to 9, wherein reporting an error with the network node with zero delay further comprises providing, to the network node, one or more reasons for the error.

Clause 11. The method of any of clauses 8 to 10, wherein reporting an error with the network node with zero delay further comprises providing, to the network node, a last known location and a time when the UE was at the last known location.

Clause 12. The method of any of clauses 8 to 11, wherein the UE determines the location information for the UE and reports the location information for the UE to the network node with non-zero delay or reports the error to the network with zero delay based on a quality of service (QoS) class associated with the UE, with the no-delay scheduled location request, or combinations thereof.

Clause 13. The method of clause 12, wherein the UE determines the location information for the UE and reports the location information for the UE to the network node with non-zero delay if the QoS class is an assured class and wherein the UE reports the error to the network with zero delay if the QoS class is a best effort class.

Clause 14. A method of wireless communication performed by a network node, the method comprising: determining that a location of a user equipment (UE) at a future time T1 is desired; and sending, to the UE, a no-delay scheduled location request that identifies a future time T1 for reporting a location of the UE.

Clause 15. The method of clause 14, wherein the no-delay scheduled location request comprises a scheduled location request having a response quality of service (QoS) attribute indicating no delay.

Clause 16. The method of any of clauses 14 to 15, further comprising: receiving, from the UE, a response to the no-delay scheduled location request.

Clause 17. The method of clause 16, wherein the response is received at a time T2 that occurs before time T1 and comprises a predicted location for the UE at time T1.

Clause 18. The method of any of clauses 16 to 17, wherein the response is received at a time T2 that occurs before time T1 and comprises an actual location of the UE at time T2, which is also predicted to be the location for the UE at time T1.

Clause 19. The method of any of clauses 16 to 18, wherein the response is received at time T1 and comprises an actual location for the UE at time T1.

Clause 20. The method of any of clauses 16 to 19, wherein the response is received at time T1 and reports an error indicating that the location for the UE at time T1 is unknown.

Clause 21. The method of clause 20, wherein the response further indicates one or more reasons for the error.

Clause 22. The method of any of clauses 20 to 21, wherein the response further provides a last known location of the UE and a time when the UE was at the last known location.

Clause 23. The method of any of clauses 16 to 22, wherein the response is received at time T3 that occurs after time T1 and comprises an actual location for the UE at time T1.

Clause 24. The method of any of clauses 14 to 23, wherein the network node comprises a location management function (LMF).

Clause 25. The method of any of clauses 14 to 24, wherein the network node comprises a gateway mobile location center (GMLC).

Clause 26. The method of any of clauses 14 to 25, further comprising: receiving, from the UE, a request for the location of the UE at the future time T1, wherein the determining that the location of the UE at the future time T1 is desired is based on receiving the request from the UE.

Clause 27. A method of wireless communication performed by a network node, the method comprising: determining that a location of a user equipment (UE) at a future time T1 is desired; determining that a no-delay scheduled location request that identifies the future time T1 for reporting a location of the UE may not complete before time T1; and performing one of: sending, to the UE, a with-delay scheduled location request for time T1; sending, to the UE, a with-delay non-scheduled location request for time T1; sending to the UE, a no-delay non-scheduled location request for time T1; sending, to the UE, a no-delay scheduled location request for a time T3 that occurs after time T1; or waiting until time T1, and then sending, to the UE, a with-delay non-scheduled location request.

Clause 28. The method of clause 27, wherein the no-delay scheduled location request or the no-delay non-scheduled location request comprises a scheduled or non-scheduled location request having a response quality of service (QoS) attribute indicating no delay and wherein the with-delay scheduled location request or the with-delay non-scheduled location request comprises a scheduled or non-scheduled location request having a response quality of service (QoS) attribute indicating low delay or delay tolerant.

Clause 29. The method of clause 28, further comprising: receiving, from the UE, a response to location request.

Clause 30. The method of any of clauses 27 to 29, wherein the network node comprises a location management function (LMF).

Clause 31. The method of any of clauses 27 to 30, wherein the network node comprises a gateway mobile location center (GMLC).

Clause 32. An apparatus comprising a memory, a communication interface, and at least one processor communicatively coupled to the memory and the communication interface, the memory, the communication interface, and the at least one processor configured to perform a method according to any of clauses 1 to 31.

Clause 33. An apparatus comprising means for performing a method according to any of clauses 1 to 31.

Clause 34. A non-transitory computer-readable medium storing computer-executable instructions, the computer-executable comprising at least one instruction for causing a computer or processor to perform a method according to any of clauses 1 to 31.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programmable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method of wireless communication performed by a user equipment (UE), the method comprising:
receiving, from a network node, a no-delay scheduled location request that identifies a future time T1 for reporting a location of the UE; and
determining, at a time T2 that occurs before time T1, location information for an expected location of the UE at time T1, the location information comprising a location measurement, a determined location that is determined based on a location measurement, or combinations thereof.

2. The method of claim 1, wherein the no-delay scheduled location request comprises a scheduled location request having a response quality of service (QoS) attribute indicating no delay.

3. The method of claim 1, wherein the location information for the expected location of the UE at time T1 comprises the location of the UE at time T2, which the UE predicts will also be its location at time T1.

4. The method of claim 1, wherein the location information for the expected location of the UE at time T1 comprises a predicted location for the UE at time T1, which is different from the location of the UE at time T2.

5. The method of claim 1, further comprising:
reporting, to the network node, the location information for the expected location of the UE at time T1 as determined at time T2.

6. The method of claim 5, wherein the location information for the expected location of the UE at time T1 is reported to the network node at time T1.

7. The method of claim 5, wherein the location information for the expected location of the UE at time T1 is reported to the network node before time T1.

8. A method of wireless communication performed by a user equipment (UE), the method comprising:
receiving, from a network node, a no-delay scheduled location request that identifies a future time T1 for reporting a location of the UE;
determining, at time T1, that a location of the UE is not yet known; and either:
determining location information for the UE, the location information comprising a location measurement, a determined location that is determined based on a location measurement, or combinations thereof, and reporting the location information for the UE to the network node with non-zero delay; or
reporting an error to the network node with zero delay.

9. The method of claim 8, wherein the no-delay scheduled location request comprises a scheduled location request having a response quality of service (QoS) attribute indicating no delay.

10. The method of claim 8, wherein reporting an error with the network node with zero delay further comprises providing, to the network node, one or more reasons for the error.

11. The method of claim 8, wherein reporting an error with the network node with zero delay further comprises providing, to the network node, a last known location and a time when the UE was at the last known location.

12. The method of claim 8, wherein the UE determines the location information for the UE and reports the location information for the UE to the network node with non-zero delay or reports the error to the network with zero delay based on a quality of service (QoS) class associated with the UE, with the no-delay scheduled location request, or combinations thereof.

13. The method of claim 12, wherein the UE determines the location information for the UE and reports the location information for the UE to the network node with non-zero delay if the QoS class is an assured class and wherein the UE reports the error to the network with zero delay if the QoS class is a best effort class.

14. A method of wireless communication performed by a network node, the method comprising:
determining that a location of a user equipment (UE) at a future time T1 is desired; and
sending, to the UE, a no-delay scheduled location request that identifies a future time T1 for reporting a location of the UE.

15. The method of claim 14, wherein the no-delay scheduled location request comprises a scheduled location request having a response quality of service (QoS) attribute indicating no delay.

16. The method of claim 14, further comprising:
receiving, from the UE, a response to the no-delay scheduled location request.

17. The method of claim 16, wherein the response is received at a time T2 that occurs before time T1 and comprises a predicted location for the UE at time T1.

18. The method of claim 16, wherein the response is received at a time T2 that occurs before time T1 and comprises an actual location of the UE at time T2, which is also predicted to be the location for the UE at time T1.

19. The method of claim 16, wherein the response is received at time T1 and comprises an actual location for the UE at time T1.

20. The method of claim 16, wherein the response is received at time T1 and reports an error indicating that the location for the UE at time T1 is unknown.

21. The method of claim 20, wherein the response further indicates one or more reasons for the error.

22. The method of claim 20, wherein the response further provides a last known location of the UE and a time when the UE was at the last known location.

23. The method of claim 16, wherein the response is received at time T3 that occurs after time T1 and comprises an actual location for the UE at time T1.

24. The method of claim 14, wherein the network node comprises a location management function (LMF).

25. The method of claim 14, wherein the network node comprises a gateway mobile location center (GMLC).

26. The method of claim 14, further comprising:
receiving, from the UE, a request for the location of the UE at the future time T1, wherein the determining that the location of the UE at the future time T1 is desired is based on receiving the request from the UE.

27. A method of wireless communication performed by a network node, the method comprising:
determining that a location of a user equipment (UE) at a future time T1 is desired;
determining that a no-delay scheduled location request that identifies the future time T1 for reporting a location of the UE may not complete before time T1; and
performing one of:
sending, to the UE, a with-delay scheduled location request for time T1;
sending, to the UE, a with-delay non-scheduled location request for time T1;
sending to the UE, a no-delay non-scheduled location request for time T1;
sending, to the UE, a no-delay scheduled location request for a time T3 that occurs after time T1; or
waiting until time T1, and then sending, to the UE, a with-delay non-scheduled location request.

28. The method of claim 27, wherein the no-delay scheduled location request or the no-delay non-scheduled location request comprises a scheduled or non-scheduled location request having a response quality of service (QoS) attribute indicating no delay and wherein the with-delay scheduled location request or the with-delay non-scheduled location request comprises a scheduled or non-scheduled location request having a response quality of service (QoS) attribute indicating low delay or delay tolerant.

29. The method of claim 28, further comprising:
receiving, from the UE, a response to location request.

30. The method of claim 27, wherein the network node comprises a location management function (LMF).

31. The method of claim 27, wherein the network node comprises a gateway mobile location center (GMLC).

32. A user equipment (UE), comprising:
a memory;
a communication interface; and
at least one processor communicatively coupled to the memory and the communication interface, the at least one processor configured to:
receive, via the communication interface, from a network node, a no-delay scheduled location request that identifies a future time T1 for reporting a location of the UE; and
determine, at time T2 that occurs before time T1, location information for an expected location of the UE at time T1, the location information comprising a location measurement, a determined location that is determined based on a location measurement, or combinations thereof.

33. The UE of claim 32, wherein the no-delay scheduled location request comprises a scheduled location request having a response quality of service (QoS) attribute indicating no delay.

34. The UE of claim 32, wherein the location information for the expected location of the UE at time T1 comprises the location of the UE at time T2, which the UE predicts will also be its location at time T1.

35. The UE of claim 32, wherein the location information for the expected location of the UE at time T1 comprises a predicted location for the UE at time T1, which is different from the location of the UE at time T2.

36. The UE of claim 32, wherein the at least one processor is further configured to:
report, to the network node, the location information for the expected location of the UE at time T1 as determined at time T2.

37. The UE of claim 36, wherein the location information for the expected location of the UE at time T1 is reported to the network node at time T1.

38. The UE of claim 36, wherein the location information for the expected location of the UE at time T1 is reported to the network node before time T1.

39. A user equipment (UE), comprising:
a memory;
a communication interface; and
at least one processor communicatively coupled to the memory and the communication interface, the at least one processor configured to:
receive, via the communication interface, from a network node, a no-delay scheduled location request that identifies a future time T1 for reporting a location of the UE;
determine, at time T1, that a location of the UE is not yet known; and either:
determine location information for the UE, the location information comprising a location measurement, a determined location that is determined based on a location measurement, or combinations thereof, and report the location information for the UE to the network node with non-zero delay; or
report an error to the network node with zero delay.

40. The UE of claim 39, wherein the no-delay scheduled location request comprises a scheduled location request having a response quality of service (QoS) attribute indicating no delay.

41. The UE of claim 39, wherein the at least one processor being configured to report an error with the network node with zero delay comprises the at least one processor being configured to provide, to the network node, one or more reasons for the error.

42. The UE of claim 39, wherein the at least one processor being configured to report an error with the network node with zero delay comprises the at least one processor being configured to provide, to the network node, a last known location and a time when the UE was at the last known location.

43. The UE of claim 39, wherein the UE determines the location information for the UE and reports the location information for the UE to the network node with non-zero delay or reports the error to the network with zero delay based on a quality of service (QoS) class associated with the UE, with the no-delay scheduled location request, or combinations thereof.

44. The UE of claim 43, wherein the UE determines the location information for the UE and reports the location information for the UE to the network node with non-zero delay if the QoS class is an assured class and wherein the UE reports the error to the network with zero delay if the QoS class is a best effort class.

45. A network node, comprising:
a memory;
a communication interface; and
at least one processor communicatively coupled to the memory and the communication interface, the at least one processor configured to:
determine that a location of a user equipment (UE) at a future time T1 is desired; and
cause the communication interface to send, to the UE, a no-delay scheduled location request that identifies the future time T1 for reporting a location of the UE.

46. The network node of claim 45, wherein the no-delay scheduled location request comprises a scheduled location request having a response quality of service (QoS) attribute indicating no delay.

47. The network node of claim 45, wherein the at least one processor is further configured to:
receive, via the communication interface, from the UE, a response to the no-delay scheduled location request.

48. The network node of claim 47, wherein the response is received at a time T2 that occurs before time T1 and comprises a predicted location for the UE at time T1.

49. The network node of claim 47, wherein the response is received at a time T2 that occurs before time T1 and comprises an actual location of the UE at time T2, which is also predicted to be the location for the UE at time T1.

50. The network node of claim 47, wherein the response is received at time T1 and comprises an actual location for the UE at time T1.

51. The network node of claim 47, wherein the response is received at time T1 and reports an error indicating that the location for the UE at time T1 is unknown.

52. The network node of claim 51, wherein the response further indicates one or more reasons for the error.

53. The network node of claim 51, wherein the response further provides a last known location of the UE and a time when the UE was at the last known location.

54. The network node of claim 47, wherein the response is received at time T3 that occurs after time T1 and comprises an actual location for the UE at time T1.

55. The network node of claim 45, wherein the network node comprises a location management function (LMF).

56. The network node of claim 45, wherein the network node comprises a gateway mobile location center (GMLC).

57. The network node of claim 45, wherein the at least one processor is further configured to:
receive, via the communication interface, from the UE, a request for the location of the UE at the future time T1, wherein the at least one processor is configured to determine that the location of the UE at the future time T1 is desired based on receiving the request from the UE.

58. A network node, comprising:
a memory;
a communication interface; and
at least one processor communicatively coupled to the memory and the communication interface, the at least one processor configured to:
determine that a location of a user equipment (UE) at a future time T1 is desired;
determine that a no-delay scheduled location request that identifies the future time T1 for reporting a location of the UE may not complete before time T1; and
perform one of:
send, to the UE, a with-delay scheduled location request;
send, to the UE, a with-delay non-scheduled location request;
send to the UE, a no-delay non-scheduled location request; or
wait until time T1, and then send, to the UE, a with-delay non-scheduled location request.

59. The network node of claim 58, wherein the no-delay scheduled location request or the no-delay non-scheduled location request comprises a scheduled or non-scheduled location request having a response quality of service (QoS) attribute indicating no delay and wherein the with-delay scheduled location request or the with-delay non-scheduled location request comprises a scheduled or non-scheduled location request having a response quality of service (QoS) attribute indicating low delay or delay tolerant.

60. The network node of claim 59, wherein the at least one processor is further configured to:
receive, via the communication interface, from the UE, a response to location request.

61. The network node of claim 58, wherein the network node comprises a location management function (LMF).

62. The network node of claim 58, wherein the network node comprises a gateway mobile location center (GMLC).

63. A user equipment (UE), comprising:
means for receiving, from a network node, a no-delay scheduled location request that identifies a future time T1 for reporting a location of the UE; and
means for determining, at a time T2 that occurs before time T1, location information for an expected location of the UE at time T1, the location information comprising a location measurement, a determined location that is determined based on a location measurement, or combinations thereof.

64. A user equipment (UE), comprising:
means for receiving, from a network node, a no-delay scheduled location request that identifies a future time T1 for reporting a location of the UE;
means for determining, at time T1, that a location of the UE is not yet known; and
means for either:
determining location information for the UE, the location information comprising a location measurement, a determined location that is determined based on a location measurement, or combinations thereof, and reporting the location information for the UE to the network node with non-zero delay; or
reporting an error to the network node with zero delay.

65. A network node, comprising:
means for determining that a location of a user equipment (UE) at a future time T1 is desired; and
means for sending, to the UE, a no-delay scheduled location request that identifies the future time T1 for reporting a location of the UE.

66. A network node, comprising:
means for determining that a location of a user equipment (UE) at a future time T1 is desired;
means for determining that a no-delay scheduled location request that identifies future time T1 for reporting a location of the UE may not complete before time T1; and
means for performing one of:
sending, to the UE, a with-delay scheduled location request for time T1;
sending, to the UE, a with-delay non-scheduled location request for time T1;
sending to the UE, a no-delay non-scheduled location request for time T1;
sending, to the UE, a no-delay scheduled location request for a time T3 that occurs after time T1; or
waiting until time T1, and then sending, to the UE, a with-delay non-scheduled location request.

67. A non-transitory computer-readable medium storing computer-executable instructions that, when executed by a user equipment (UE), cause the UE to:
receive, from a network node, a no-delay scheduled location request that identifies a future time T1 for reporting a location of the UE; and
determine, at a time T2 that occurs before time T1, location information for an expected location of the UE at time T1, the location information comprising a location measurement, a determined location that is determined based on a location measurement, or combinations thereof.

68. A non-transitory computer-readable medium storing computer-executable instructions that, when executed by a UE, cause the UE to:
receive, from a network node, a no-delay scheduled location request that identifies a future time T1 for reporting a location of the UE;
determine, at time T1, that a location of the UE is not yet known; and either:
determine the location information for the UE and report the location information for the UE to the network node with non-zero delay; or
report an error to the network node with zero delay.

69. A non-transitory computer-readable medium storing computer-executable instructions that, when executed by a network node, cause the network node to:
determine that a location of a user equipment (UE) at a future time T1 is desired; and
send, to the UE, a no-delay scheduled location request that identifies the future time T1 for reporting a location of the UE.

70. A non-transitory computer-readable medium storing computer-executable instructions that, when executed by a network node, cause the network node to:
determine that a location of a user equipment (UE) at a future time T1 is desired;
determine that a no-delay scheduled location request that identifies future time T1 for reporting a location of the UE may not complete before time T1; and
perform one of:
send, to the UE, a with-delay scheduled location request for time T1;
send, to the UE, a with-delay non-scheduled location request for time T1;
send to the UE, a no-delay non-scheduled location request for time T1;
send, to the UE, a no-delay scheduled location request for a time T3 that occurs after time T1; or
wait until time T1, and then send, to the UE, a with-delay non-scheduled location request.
